(19) United States
(12) Patent Application Publication
(10) Pub. No.: US 2025/0047825 A1
(43) Pub. Date: Feb. 6, 2025

(54) IMAGING SYSTEM WITH RELIABLE DEPTH DETECTION AND METHOD THEREFOR

(71) Applicant: Symbotic LLC, Wilmington, MA (US)

(72) Inventors: Gene MALKIN, Brookline, MA (US); Scott DENENBERG, Newtown, MA (US); Valentina CHAMORRO, Somerville, MA (US); Lev PERSITS, Cambridge, MA (US); Alberto MOEL, Cambridge, MA (US); U. Murat Erdem, Wilmington, MA (US)

(21) Appl. No.: 18/920,605

(22) Filed: Oct. 18, 2024

Related U.S. Application Data
(63) Continuation-in-part of application No. 17/577,487, filed on Jan. 18, 2022.
Application No. 17/577,487 is a continuation-in-part of application No. 17/103,427, filed on Nov. 24, 2020.
Application No. 17/103,427 is a continuation of application No. 16/553,724, filed on Aug. 28, 2019, now Pat. No. 10,887,578.
(60) Provisional application No. 62/724,941, filed on Aug. 30, 2018.

(51) Int. Cl. H04N 13/246; G01K 13/00; G06T 7/80; H04N 13/00; H04N 13/194; H04N 13/204; H04N 13/254; H04N 13/271; H04N 25/60

(52) U.S. Cl. CPC H04N 13/246; G06T 7/85; H04N 13/194; H04N 13/204; H04N 13/254; H04N 13/271; H04N 25/60; G01K 13/00; H04N 2013/0081

(57) ABSTRACT

An image processing system includes at least two three-dimensional sensors and a controller. Each of the sensors being for illuminating a corresponding field of view of the sensor, and generating an output array of pixelwise values indicative of distances to illuminated objects in the field of view, each sensor being configured to generate illumination at least at two different frequencies so that objects in the corresponding field of view are illuminated at the two different frequencies. The controller is communicably connected to the at least two sensors to receive pixelwise data from each sensor embodying intensity and distance information from the illuminated objects. The controller is configured to disambiguate a distance to each of the illuminated objects, resolve error in the received pixelwise data due to periodic distance ambiguity, and determine corrected pixelwise values indicative of true distance via each sensor illumination at the at least two different frequencies.

### CROSS-REFERENCE TO RELATED APPLICATIONS

This application is a continuation-in-part of U.S. Ser. No. 17/577,487 (filed Jan. 18, 2022), which is a continuation-in-part of U.S. Ser. No. 17/103,427 (filed Nov. 24, 2020), which is a continuation of U.S. Ser. No. 16/553,724 (filed on Aug. 28, 2019), now U.S. Pat. No. 10,887,578, which claims priority to and the benefit of U.S. Ser. No. 62/724,941 (filed on Aug. 30, 2018). The entire disclosures of these priority documents are hereby incorporated by reference in their entireties.

### BACKGROUND

### 1. Field

The field of the invention relates, generally, to monitoring of industrial environments where humans and machinery interact or come into proximity, and in particular to systems and methods for detecting conditions in a monitored workspace that do not conform to industry safety standards/practices.

### 2. Brief Description of Related Developments

Industrial machinery may present potential hazards to humans. Some machinery may be completely shut down, while other machinery may have a variety of operating states, some of which may present potential hazards and some of which may not. In some cases, the degree of any potential hazard may depend on the location or distance of the human with respect to the machinery. As a result, many “guarding” approaches have been developed to separate humans and machines and to prevent interaction between machinery and humans. One very simple and common type of guarding is simply a cage that surrounds the machinery, configured such that opening the door of the cage causes an electrical circuit to place the machinery in a shut-down (immobile) state. If the door is placed sufficiently far from the machinery to ensure that the human cannot reach the machinery before the machinery shuts down, this ensures that humans can never approach the machinery while it is operating. Of course, this prevents all interaction between human and machine, and severely constrains use of the workspace.

The problem is exacerbated if not only humans but also the machinery (e.g., a robot) can move within the workspace. Both may change position and configuration in rapid and uneven ways. Typical industrial robots are stationary, but nonetheless have powerful arms that may present potential hazards over a wide “envelope” of possible movement trajectories. Additionally, robots are often mounted on a rail or other type of external axis, and additional machinery is often incorporated into the robot's end effector, both of which increase the effective total operating envelope of the robot.

Sensors such as light curtains can be substituted for cages or other physical barriers, providing alternative methods to prevent humans and machinery from coming into contact. Sensors such as two-dimensional (2D) light detection and ranging (LIDAR) sensors can provide more sophisticated capabilities, such as allowing the industrial machinery or robot to slow down or issue a warning when an intrusion is detected in an outer zone and stop only when an intrusion is detected in an inner zone. Additionally, a system using a 2D LIDAR can define multiple zones in a variety of shapes.

The guarding equipment must typically comply with stringent industry standards regarding function of the guarding equipment, such as ISO 13849, IEC 61508, and IEC 62061. These standards specify maximum failure rates for hardware components and define rigorous development practices for both hardware and software components that must be complied with in order for a system to be considered safety-rated for use in industrial settings.

Such guarding systems must ensure that potentially hazardous conditions and system failures can be detected with very high probability, and that the system responds to such events by transitioning the equipment being controlled into a safe state. For example, a system that detects zone intrusion may be biased toward registering an intrusion, i.e., risking false positives in order to avoid hazardous interaction between a machine and a human due to a false negative.

One new class of sensor that shows significant promise for use in machine guarding provides three-dimensional (3D) depth information. Examples of such sensors include 3D time-of-flight cameras, 3D LIDAR, and stereo vision cameras. These sensors offer the ability to detect and locate intrusions into the area surrounding industrial machinery in 3D, which has several advantages over 2D systems. In particular, for complex workcells it can be very difficult to determine a combination of 2D planes that effectively covers the entire space for monitoring purposes; 3D sensors, properly configured, can alleviate this issue.

For example, a 2D LIDAR system guarding the floor space of an industrial robot will have to preemptively stop the robot when an intrusion is detected well beyond an arm's-length distance away from the robot (the “Protective Separation Distance” or PSD), because if the intrusion represents a person's legs, that person's arms could be much closer and would be undetectable by the 2D LIDAR system. For sensors that cannot detect arms or hands, the PSD has an extra term called the intrusion distance that is typically set to 850 mm. A 3D system, by contrast, can allow the robot to continue to operate until the person actually stretches his or her arm towards the robot. This provides a much tighter interlock between the actions of the machine and the actions of the human, which avoids premature or unnecessary shutdowns, facilitates many new safety-rated applications and workcell designs, and saves space on the factory floor (which is always at a premium).

Another application of 3D sensing involves tasks that are best achieved by humans and machines working collaboratively together. Humans and machines have very different strengths and weaknesses. Typically, machines may be stronger, faster, more precise, and offer greater repeatability. Humans have flexibility, dexterity, and judgment far beyond the abilities of even the most advanced machines. An example of a collaborative application is the installation of a dashboard in a car, where the dashboard is heavy and difficult for a human to maneuver, but attaching it requires a variety of connectors and fasteners that require human dexterity. A guarding system based on 3D sensing could enable industrial engineers to design processes that optimally allocate subtasks to humans and machines in a manner that best exploits their different capabilities while preserving safety-rating of the system.

2D and 3D sensing systems may share underlying technologies. RGB cameras and stereo vision cameras, for example, utilize a lens and sensor combination (i.e., a camera) to capture an image of a scene that is then analyzed algorithmically. A camera-based sensing system typically includes several key components. A light source illuminates the object being inspected or measured. This light source may be part of the camera, as in active sensing systems, or independent of the camera, such as a lamp illuminating the field of view of the camera, or even ambient light. A lens focuses the reflected light from the object and provides a wide field of view. An image sensor (usually a CCD or CMOS array) converts light into electrical signals. A camera module usually integrates the lens, image sensor, and necessary electronics to provide electrical input for further analysis.

The signal from the camera module is fed to an image-capture system, such as a frame grabber, which stores and further processes the 2D or 3D image signal. A processor runs image-analysis software for identification, measurement, and location of objects within the captured scene. Depending on the specific design of the system, the processor can use central-processing units (CPUs), graphics-processing units (GPUs), field-programmable gate arrays (FPGAs), or any number of other architectures, which may be deployed in a stand-alone computer or integrated in the camera module.

2D camera-based methods are well-suited to detecting defects or taking measurements using well-known image-processing techniques, such as edge detection or template matching. 2D sensing is used in unstructured environments and, with the aid of advanced image-processing algorithms, may compensate for varying illumination and shading conditions. However, algorithms for deriving 3D information from 2D images may lack reliability and suitability for safety-critical applications, as their failure modes are hard to characterize.

While a typical image provides 2D information of an object or space, a 3D camera adds another dimension and estimates the distance to objects and other elements in a scene. 3D sensing can therefore provide the 3D contour of an object or space, which can itself be used to create a 3D map of the surrounding environment and position an object relative to this map. Reliable 3D vision overcomes many problems of 2D vision, as the depth measurement can be used to easily separate foreground from background. This is particularly useful for scene understanding, where the first step is to segment the subject of interest (foreground) from other parts of the image (background).

A widely used 3D camera-based sensing approach is stereoscopic vision, or stereo vision. Stereo vision generally uses two spaced-apart cameras in a physical arrangement similar to human eyes. Given a point-like object in space, the camera separation will lead to a measurable disparity of the object positions in the two camera images. Using simple pinhole camera geometry, the object's position in 3D can be computed from the images in each of the cameras. This approach is intuitive, but its real-world implementations are often not as simple. For example, features of the target need to be recognized first so that the two images can be compared for triangulation, but feature recognition involves relatively complex computation and may consume substantial processing power.

Further, 3D stereoscopic vision is highly dependent on the background lighting environment, and its effectiveness is degraded by shadows, occlusions, low contrast, lighting changes, or unexpected movements of the object or sensors. Therefore, often more than two sensors will be used to obtain a surrounding view of the target and thereby handle occlusions, or to provide redundancy to compensate for errors caused by a degraded and uncontrolled environment. Another common alternative is the use of structured light patterns to enhance a system's ability to detect features.

Another approach to 3D imaging utilizes lasers or other active light sources and detectors. A light source-detector system is similar to a camera-based system in that it also integrates lens and image sensors and converts optical signals into electrical signals, but there is no image captured. Instead, the image sensor measures the change of position and/or intensity of a tightly focused light beam, usually a laser beam, over time. This change of position and/or intensity of the detected light beam is used to determine object alignment, throughput, reflective angles, time of flight, or other parameters to create images or maps of the space or object under observation. Light source-detector combinations include active triangulation, structured light, LIDAR, and time-of-flight (ToF) sensors.

Active triangulation mitigates the environmental limitations of stereoscopic 3D by proactively illuminating objects under study with a narrowly focused light source. The wavelength of the active illumination can be controlled, and the sensors can be designed to ignore light at other wavelengths, thereby reducing ambient light interference. Further, the location of the light source can be changed, allowing the object to be scanned across points and from multiple angles to provide a complete 3D picture of the object.

3D structured light is another approach based on triangulation and an active light source. In this approach, a pre-designed light pattern, such as parallel lines, a grid, or speckles, is beamed on the target. The observed reflected pattern will be distorted by the contour of the target, and the contour as well as the distance to the object can be recovered by analysis of the distortion. Successive projections of coded or phase-shifted patterns are often required to extract a single depth frame, which leads to lower frame rates, which in turn mean that the subject must remain relatively still during the projection sequence to avoid blurring.

Compared to a simple active triangulation, structured light adds “feature points” to the target. As feature points are pre-determined (i.e., spatially encoded) and very recognizable, the structured light approach makes feature recognition easier and triangulation therefore faster and more reliable. This technology shifts complexity from the receiver to the source and requires more sophisticated light sources but simpler sensors and lower computational intensity.

Scanning LIDAR measures the distance to an object or space by illuminating it with a pulsed laser beam and measuring the reflected pulses with a sensor. By scanning the laser beam in 2D and 3D, differences in laser return times and wavelengths can be used to make 2D or 3D representations of the scanned object or space. LIDAR uses ultraviolet (UV), visible, or near-infrared light, which is typically reflected via backscattering to form an image or map of the space or object being under study.

A 3D time-of-flight (ToF) camera works by illuminating the scene with a modulated light source and observing the reflected light. The phase shift between the illumination and the reflection is measured and translated to distance. Unlike LIDAR, the light source is not scanned; instead, the entire scene is illuminated simultaneously, resulting in higher frame rates. Typically, the illumination is from a solid-state laser or LED operating in the near-infrared range (of about 800-1500 nm) invisible to the human eye. Typically, an imaging sensor responsive to the same spectrum receives the light and converts the photonic energy to electrical current, then to charge, and then to a digitized value. The light entering the sensor has a component due to ambient light, and a component from the modulated illumination source. Distance (depth) information is only embedded in the component reflected from the modulated illumination. A high ambient component can saturate the sensor, introducing nonlinearities on the measurement and reducing the signal to noise ratio (SNR). Hence, a sufficiently strong component of the reflected modulated illumination and a low enough ambient component is necessary to achieve a high enough SNR for an accurate measurement of the distance between the sensor and the reflected object. Insufficient reflected illumination can be, among other reasons, a result of insufficient illumination or low reflectivity of the objects being illuminated.

To detect phase shifts between the illumination and the reflection, the light source in a 3D ToF camera may be pulsed to produce a square wave, or modulated by a continuous-wave source, typically a sinusoid. Distance is measured for every pixel in a 2D addressable array, resulting in a depth map, or collection of 3D points. The depth map may be rendered or otherwise projected into a 3D space as a collection of points, or a point cloud. The 3D points can be mathematically connected to form a mesh onto which a textured surface may be mapped.

3D ToF cameras have been used in industrial settings but, to date, the deployments have tended to involve non-safety critical applications such as bin-picking and palletizing. Because existing off-the-shelf 3D ToF cameras are not safety-rated, they cannot be used in safety-critical applications such as machine guarding or collaborative robotics applications, meeting, for example, the ISO 10218 standard, which at the time of this writing employs a Performance Level d (PLd) performance standard. Accordingly, there is a need for architectures and techniques that render 3D cameras, including ToF cameras, useful in applications requiring a high degree of safety and conformance to industry-recognized safety standards.

There is a need for architectures, sensing and imaging techniques that render 3D cameras, including ToF cameras, useful and reliable in applications requiring a sufficiently high degree of safety and in conformance with industry-recognized safety standards. U.S. Pat. Nos. 10,887,578 and 10,887,579 describe an architecture utilizing one or more 3D cameras (e.g., ToF cameras) in industrial safety applications. However, those two patents are silent on what is the required imaging performance of such a camera, and how to achieve such a level of performance.

For various reasons, on any given frame, a small fraction of the pixels in a ToF image may provide an incorrect range measurement or no range measurement at all. For non-safety applications, such incorrect pixels are typically not a major concern. However, for safety applications, an incorrect pixel could result in an undesired condition.

Accordingly, the present disclosure addresses a number of those issues.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the present disclosure. In the following description, various aspects of the present disclosure are described with reference to the following drawings, in which:

FIG. 1 schematically illustrates a camera architecture in accordance with the present disclosure.

FIG. 2 schematically illustrates the data flow of the camera architecture illustrated in FIG. 1.

FIG. 3 schematically illustrates camera calibration in accordance with the present disclosure.

FIG. 4 schematically illustrates the calibration process in greater detail and integration with data stored in a boot file.

FIG. 5 is an exemplary schematic illustration of a workspace in accordance with the present disclosure.

FIG. 6 is an exemplary schematic illustration of an automated logistic system workspace in accordance with the present disclosure.

FIG. 7 is an exemplary exaggerated illustration of edge effects with respect to pixel identification in accordance with the present disclosure.

FIG. 8 is a flow diagram of an exemplary method in accordance with the present disclosure.

FIG. 9 is a flow diagram of an exemplary method in accordance with the present disclosure.

FIG. 10 is a schematic illustration of a portion of an image processing system including the camera architecture described herein in accordance with the present disclosure.

FIG. 11 is a flow diagram of an exemplary method in accordance with the present disclosure.

FIG. 12 is a schematic illustration of a portion of an image processing system including the camera architecture described herein in accordance with the present disclosure.

FIG. 13 is a flow diagram of an exemplary method in accordance with the present disclosure.

FIG. 14 is a flow diagram of an exemplary method in accordance with the present disclosure.

FIG. 15 is a flow diagram of an exemplary method in accordance with the present disclosure.

FIG. 16 is a flow diagram of an exemplary method in accordance with the present disclosure.

### DETAILED DESCRIPTION

The following detailed description is meant to assist the understanding of one skilled in the art and is not intended in any way to unduly limit claims connected to or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the object being referred to as being in its “singular” form.

Any reference(s) to industry standard(s) made herein are made with respect to the content of such standard(s) as it exists at the time of writing this paper. Such standard(s), to which reference is made, is/are incorporated herein by reference in its/their entirety/entireties.

In the following discussion, an integrated system for monitoring a workspace is described, classifying regions therein for safety purposes, and dynamically identifying safe states. In some cases, the latter function involves semantic analysis of a robot in the workspace and identification of the workpieces with which it interacts. It should be understood, however, that these various elements may be implemented separately or together in desired combinations; the inventive aspects discussed herein do not require all of the described elements, which are set forth together merely for ease of presentation and to illustrate their interoperability. The system as described is exemplary. The ensuing discussion describes aspects involving ToF cameras, but it should be understood that the present disclosure may utilize any form of 3D sensor capable of recording a scene and assigning depth information, typically on a pixelwise basis, to a recorded scene. Functionally, the 3D camera generates a depth map, or a depth-space 3D image that may be used by external hardware and software to classify objects in a workcell or workspace and generate control signals for machinery.

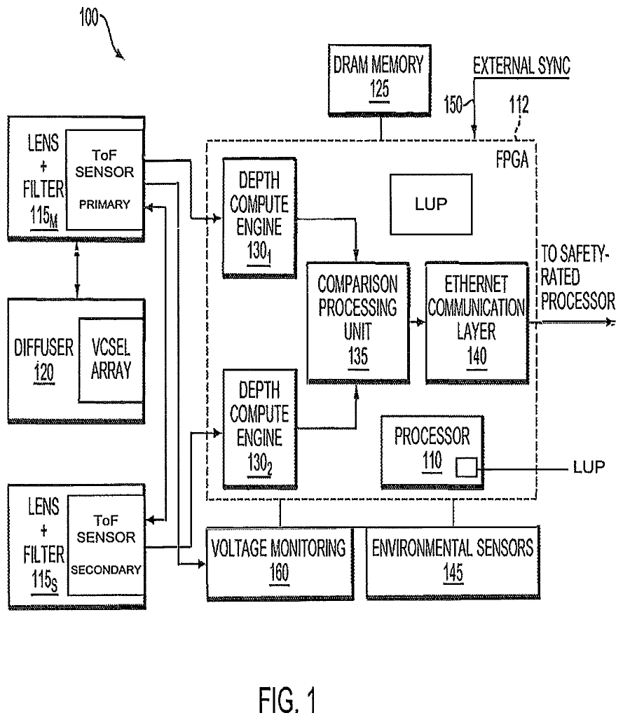

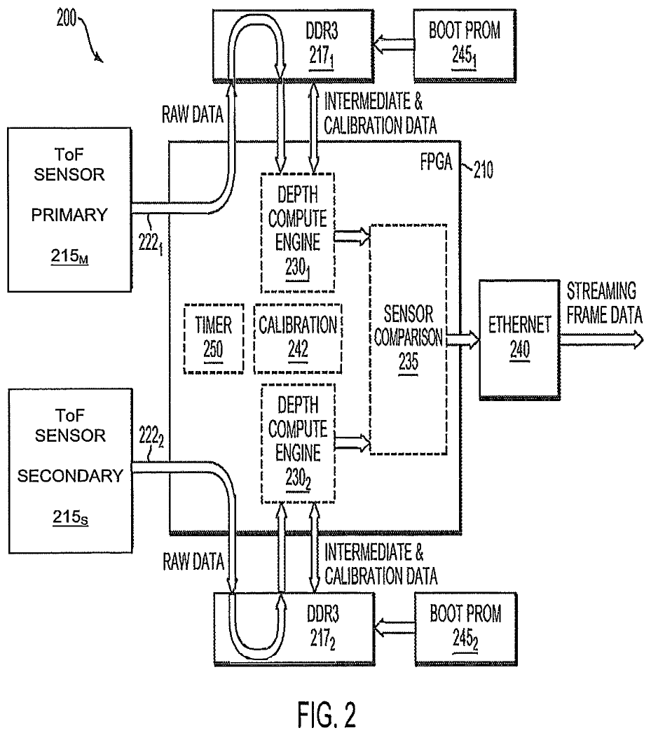

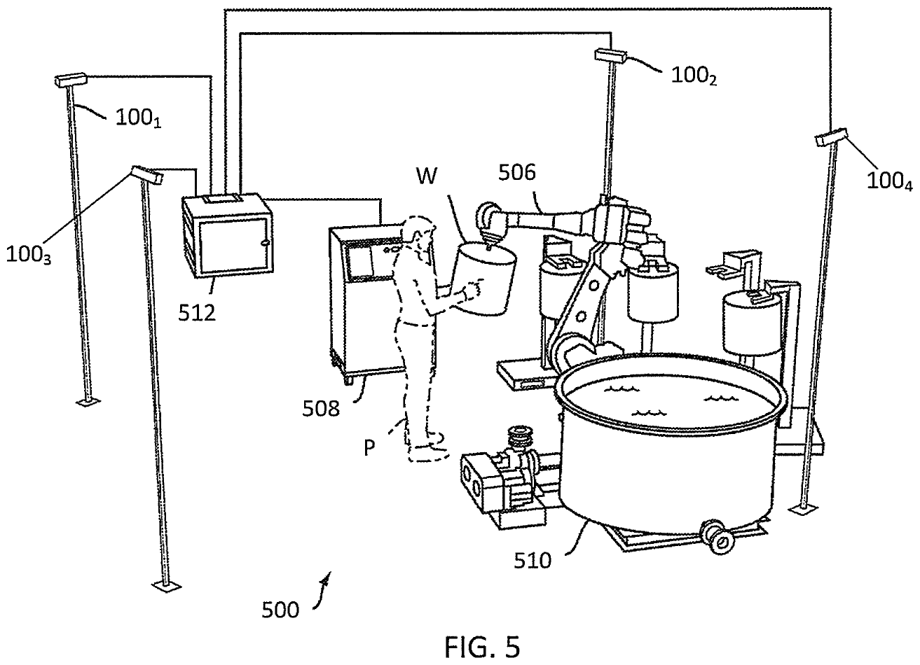

Referring to FIG. 5, an exemplary workspace 500 is illustrated. The representative system 100 of FIG. 1 (see also the architecture 200 of FIG. 2) may be employed in the workspace 500 so that the workspace 500 is monitored by a plurality of sensors representatively indicated at 100₁, 100₂, 100₃, 100₄. The sensors 100₁, 100₂, 100₃, 100₄ may be as described herein with respect to system 100 and/or the architecture 200 of FIG. 2. The mode of operation of the sensors 100₁, 100₂, 100₃, 100₄ may provide a 3D representation of the workspace 500 as obtained from images or other data obtained by the sensors 100₁, 100₂, 100₃, 100₄. As shown in FIG. 5, sensors 100₁, 100₂, 100₃, 100₄ collectively cover and can monitor the workspace 500, which includes a robot 506 controlled by a conventional robot controller 508. The robot interacts with various workpieces W, and a person P in the workspace 500 may interact with the workpieces and the robot 506. The workspace 500 may also contain various items of auxiliary equipment 510, which can complicate analysis of the workspace by occluding various portions thereof from the sensors. Indeed, any realistic arrangement of sensors will frequently be unable to “see” at least some portion of an active workspace. This is illustrated in the simplified arrangement of FIG. 5: due to the presence of the person P, at least some portion of robot controller 508 may be occluded from all sensors. In an environment that people traverse and where even stationary objects may be moved from time to time, the unobservable regions will shift and vary.

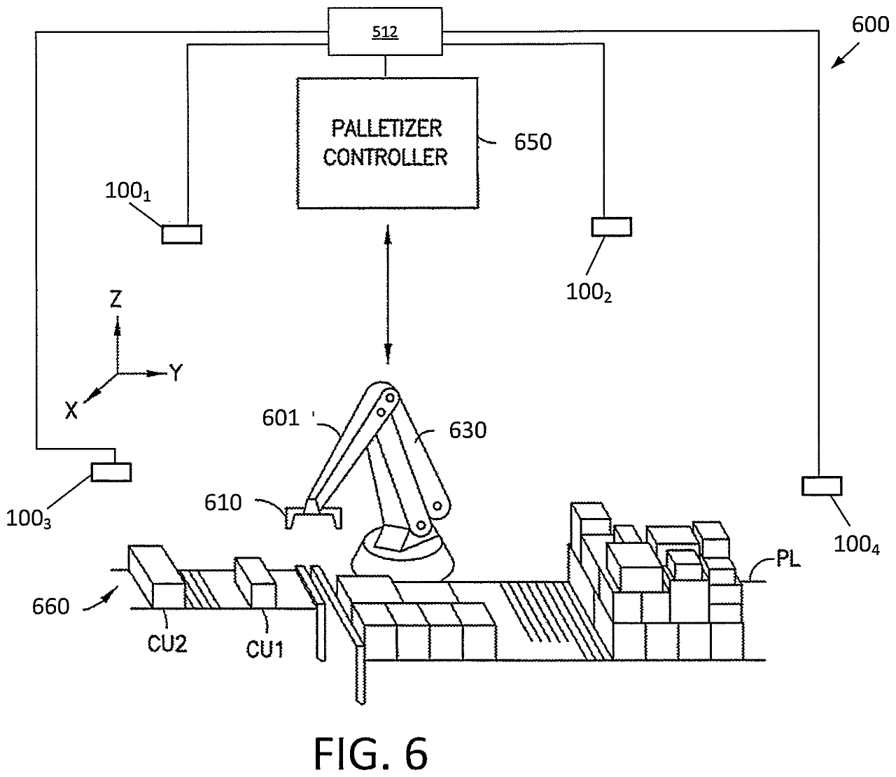

Referring to FIG. 6, an exemplary palletizing/depalletizing system 600 (also referred to as palletizing system or automated logistic system 600) is illustrated and may include a palletizer 601 such as may be used in a warehouse or distribution center in a palletizing or depalletizing role. In the palletizing role, the automated logistic system 600 may build (e.g., commission) pallet loads PL using items CU ordered by customers. In a depalletizing role, the automated logistic system 600 may unpack/remove (e.g., decommission) items CU from a pallet load PL for replenishing the items CU stored in the warehouse or distribution center with the items CU unpacked/removed from the pallet load PL. The representative system 100 of FIG. 1 (see also the architecture 200 of FIG. 2) may be employed in the automated logistic system 600 so that a palletizer workspace is monitored by a plurality of sensors representatively indicated at 100₁, 100₂, 100₃, 100₄. The sensors 100₁, 100₂, 100₃, 100₄ may be as described herein with respect to system 100 and/or the architecture 200 of FIG. 2. The mode of operation of the sensors 100₁, 100₂, 100₃, 100₄ may provide a 3D representation of the palletizer workspace as obtained from images or other data obtained by the sensors 100₁, 100₂, 100₃, 100₄. As shown in FIG. 6, sensors 100₁, 100₂, 100₃, 100₄ collectively cover and can monitor the palletizer workspace, which includes a palletizer 601, one or more conveyors 660, and a pallet PL commissioning/decommissioning area. Generally, the palletizer 601 has a suitable end effector or item grip 610 to capture items CU₁-CUₙ (n is a integer corresponding to the number of items specified by a customer order or decommissioned from the pallet load PAL) and move the case units from one location to a desired destination location for commissioning or decommissioning the pallet load PL. In the example illustrated, the item grip 610 may be capable of 3D movement (e.g. along X, Y, Z axes). The palletizer 601 may include an articulated arm 630, where the case grip 610 depends from the arm 630. The arm articulation may be such as to allow desired range of motion of the case grip 610 along one or more of the X, Y, Z axis. The palletizer 601 configuration shown in FIG. 6 is exemplary, and the palletizer may have any other suitable configurations. Case grip actuation and movements, including path and trajectory between pick and place locations are determined and commanded by the palletizer controller 650 in accordance with suitable programming. Data related to the case grip picking the case units fed the palletizer by the out-feed section, including for example, case identification, dimensions, pick position or location may be provided by any suitable system control server (such as a warehouse management system/item management system level program) to the palletizer control 650. Data related to case grip placement of the items CU onto the pallet PL such as placement location (for example coordinate locations in the desired reference frames of the pallet load may be determined or provided to the palletizer control 650 from a pallet load solution generated by a pallet load generator in a in any suitable manner. As seen in FIG. 6, items CU₁-CUₙ corresponding to a respective order (initialized for example via a warehouse management system to the item management system level program for fulfillment) may be fed to the palletizer 601 in a desired sequence. The exemplary configurations in FIG. 6 is shown as having a single out-feed conveyor 660 transporting cases to the palletizer 601, but any suitable number of conveyors may be provided to feed the items CU corresponding to a respective order to the palletizer 601. The term conveyor is used herein to mean any suitable transport or conveyance capable of transporting the items CU along a desired transport path, including for example a movable belt conveyor, roller or rotating bar conveyors or other suitable transport. The items CU₁-CUₙ may be queued and placed on the feed conveyor(s) 660 in a desired sequence and may arrive and be fed to the palletizer 601 in the same sequence. The desired case sequence may be for example established or known to the control server (e.g. item management system level program) and communicated or otherwise shared, along with other item management system related information such as item identity and item dimensions, with the palletizer controller 650. Information relating to the corresponding items CU to the respective order may also be communicated to the palletizer controller 650. As such, the palletizer controller may know the items CU making up each respective order and item information (e.g. case dimension, identity, etc.) allowing determination of the pallet load structure with the pallet load generator. Further, the item information (e.g., item dimensions, identity) and feed sequence and determination of position of the items CU for picking by the case pick 610 of the palletizer 601. As shown in FIG. 6, the palletizer 601 may operate to pick items CU₁-CUₙ from the conveyor 660. The items CU may be positioned by the conveyor 660 in a desired location with respect to a reference datum, so that the position of the item to be picked by the palletizer 601 is identified upon notification of case arrival at the desired location and if the item identity and item dimensions are known. The item pick sequence of the palletizer 601 to build the pallet load PL may be decoupled from the sequence in which items CU are fed (e.g. arrive at) the palletizer 601.

Referring to FIG. 1, a representative system 100 is illustrated where the system 100 may be configured as a camera within a single enclosure or as multiple separate components. The system 100, which may be implemented in a single housing as a camera, includes a processing unit 110 and a pair of 3D sensors 115, one of which (sensor 115_{M}) operates as a primary and the other (sensor 115_{S}) as a secondary. The camera 100 (or, in some aspects, each of the sensors 115) also includes a light source (e.g., a VCSEL laser source or any other suitable light source), suitable lenses and filters tuned to the light source. The reflected and backscattered light from the light source is captured by the lenses and recorded by the sensors 115. The light source may include a diffuser 120, although in low-power applications, a light-emitting diode (LED) may be used instead of a laser source and diffuser.

The processor 110 may be or include any suitable type of computing hardware, e.g., a microprocessor, but in various aspects may be a microcontroller, peripheral integrated circuit element, a CSIC (customer-specific integrated circuit), an ASIC (application-specific integrated circuit), a logic circuit, a digital signal processor, a programmable logic device such as an FPGA (field-programmable gate array), PLD (programmable logic device), PLA (programmable logic array), RFID processor, graphics processing unit (GPU), smart chip, or any other device or arrangement of devices that is capable of implementing the steps of the processes of the present disclosure.

In the illustrated aspect, the processor 110 operates an FPGA 112 and may advantageously provide features to support safety-rated operation, e.g., Safety Separation Design Flow to lock down place and route for safety-critical portions of the design; clock check; single event upset; CRC functions for various data and communication paths that cross the FPGA boundary; and usage of safety-rated functions for individual sub-modules. Within the processor's integrated memory and/or in a separate, primary random-access memory (RAM) 125 typically dynamic RAM, or DRAM—are instructions, conceptually illustrated as a group of modules that control the operation of the processor 110 and its interaction with the other hardware components. These instructions may be coded in any suitable programming language, including, without limitation, high-level languages such as C, C++, C#, Java, Python, Ruby, Scala, Lua, Julia, PHP or Go, utilizing, without limitation, any suitable frameworks and libraries such as TensorFlow, Keras, PyTorch, or Theano. Additionally, the software can be implemented in an assembly language and/or machine language directed to a microprocessor resident on a target device. An operating system (not shown) directs the execution of low-level, basic system functions such as memory allocation, file management and operation of mass storage devices. At a higher level, a pair of conventional depth-compute engines 130₁, 130₂ (generally referred to individually or collectively as depth-compute engine 130) receive raw 3D sensor data and assign depth values to each pixel of the recorded scene. Raw data refers to the uncalibrated data coming from a sensor (e.g., 12 bits per pixel). The RAM 125 supports error-correcting code (ECC), which is important for safety-rated applications.

Using two independent lenses and 3D sensor modules 115 creates two separate optical paths. This redundancy allows for immediate detection if one of the camera modules 115 fails during operation. Also, by not picking up the exact same image from each lens and sensor combination, additional levels of processing can be performed by an image comparison module 135, which projects the response of a pixel from one optical path into corresponding pixels of the other optical path. (This projection may be determined, for example, during a calibration phase.) Failure modes that can be detected through this comparison include errant detections due to multiple reflections and sensor-sensor interference. When the two sensors 115 agree within an established noise metric based on the performance characteristics of the cameras, the two independent images can also be used to reduce noise and/or increase resolution. Redundant sensing for dual-channel imaging ensures that reliability levels required for safety-critical operation in industrial environments can be met.

If the comparison metric computed by the comparison module 135 is within the allowed range, the merged output is processed for output according to a network communication protocol. In the illustrated aspect, output is provided by a conventional low-latency Ethernet communication layer 140. This output may be utilized by a safety-rated processor system for controlled machinery as described, for example, in U.S. Pat. No. 11,543,798 issued on Jan. 3, 2023, the entire disclosure of which is hereby incorporated by reference.

The system 100 may include one or more environmental sensors 145 to measure conditions such as temperature and humidity. In one aspect, multiple on-board temperature sensors 145 are disposed at multiple locations across the sensors 115, e.g., at the center of the illumination array, on the camera enclosure, and within the camera enclosure internally (one near the primary sensor and one near the secondary sensor), for calibrating and correcting the 3D sensing modules as system-generated heat and ambient temperature changes or drifts affect the camera's operating parameters. For example, camera temperature variations can affect the camera's baseline calibration, accuracy, and operating parameters. Calibration may be employed to establish operating temperature ranges where performance is maintained; sensor detection of conditions outside these ranges can cause a shutdown, preventing undesired failures. As discussed in greater detail below, temperature correction parameters may be estimated during calibration and then applied in real-time during operation. In one aspect, the system 100 identifies a stable background image and uses this to constantly verify the correctness of the calibration and that the temperature-corrected image remains stable over time.

A fundamental problem with the use of depth sensors in safety-rated systems is that the depth result from each pixel is not known with 100% certainty. The actual distance to an object can differ from the reported depth. The error between the reported depth and actual depth may become significant, manifesting as a mismatch between an object's actual and apparent location, and this mismatch will be randomized on a per-pixel basis. Pixel-level errors may arise from, for example, raw data saturation or clipping, unresolvable ambiguity distance as calculated by different modulation frequencies, a large intensity mismatch between different modulation frequencies, a predicted measurement error above a certain threshold due to low SNR, or excessive ambient light level. A safety-rated system where it is desired to know accurate distances cannot afford such errors. The approach taken by typical ToF cameras is to zero out the data for a given pixel if the received intensity is below a certain level. For pixels with medium or low received optical intensity, the system can either conservatively disregard the data and be totally blind for that pixel, or it can accept the camera's reported depth result, which may be off by some distance.

Accordingly, depth data provided in the sensor output may include a predicted measurement error range of the depth result, on a per-pixel basis, based on raw data processing and statistical models. For example, it is common for ToF cameras to output two values per pixel: depth and optical intensity. Intensity can be used as a rough metric of data confidence (i.e., the reciprocal of error), so instead of outputting depth and intensity, the data provided in the output may be depth and an error range. The error range may also be predicted, on a per-pixel basis, based on variables such as sensor noise, dark frame data (as described below), and environmental factors such as ambient light and temperature.

Thus, this approach represents an improvement over simple pass/fail criteria as described above, which ignore all depth data for pixels with a signal-to-noise ratio (SNR) below a threshold. With a simple pass/fail approach, depth data is presented as if there is zero measurement error, so a safety-critical process that relies on the integrity of this data may set the SNR threshold sufficiently high that the actual measurement error has no undesired impact at the system level. Pixels with medium to low SNR may still contain useful depth information despite having increased measurement error and are either completely ignored (at a high SNR threshold) or are used with the incorrect assumption of zero measurement error (at a low SNR threshold). Including the measurement error range on a per-pixel basis allows a higher-level safety-critical process to utilize information from pixels with low to mid SNR levels while properly bounding the depth result from such pixels. This may improve overall system performance and uptime over the simple pass/fail approach, although it should be noted that a pass/fail criterion for very low SNR pixels can still be used with this approach.

In accordance with the present disclosure, error detection can take different forms with the common objective of preventing erroneous depth results from being propagated to a higher-level safety-critical process, on a per-pixel basis, without simply setting a threshold for the maximum allowable error (or equivalently minimum required intensity). For example, a pixel's depth can be reported as 0 with a corresponding pixel error code. Alternatively, the depth-compute engine 130 can output the depth along with the expected range error, enabling the downstream safety-rated system to determine whether the error is sufficiently low to permit the pixel to be used.

For example, as described in U.S. Pat. No. 10,099,372 issued on Oct. 16, 2018, the entire disclosure of which is hereby incorporated by reference, a robot safety protocol may involve modulating the robot's maximum velocity (by which is meant modulating the velocity of the robot itself or any appendage thereof) proportionally to the minimum distance between any point on the robot and any point in the relevant set of sensed objects to be avoided. The robot is allowed to operate at maximum speed when the closest object is further away than some threshold distance beyond which collisions are not a concern, and the robot is halted altogether if an object is within a certain minimum distance. Sufficient margin can be added to the specified distances to account for movement of relevant objects or humans toward the robot at some maximum realistic velocity. Thus, in one approach, an outer envelope or 3D zone is generated computationally around the robot. Outside this zone, all movements of, for example, a detected person are considered safe because, within an operational cycle, they cannot bring the person sufficiently close to the robot to pose a hazard. Detection of any portion of the person's body within a second 3D zone, computationally defined (e.g., defined through computational/mathematical processes such as modeling or analysis) within the first zone, does not prohibit the robot from continuing to operate at full speed. If any portion of the detected person crosses the threshold of the second zone but is still outside a third interior zone within the second zone, the robot is signaled to operate at a slower speed. If any portion of the detected person crosses into the innermost zone or is predicted to do so within the next cycle based on a model of human movement, operation of the robot is halted.

In this case, the zones may be adjusted (or the space considered occupied by the detected person may be expanded) based on estimated depth errors. The greater the detected error, the larger the envelope of the zones or the space assumed to be occupied by the detected person will be. In this way, the robot may continue operating based on error estimates instead of shutting down because too many pixels do not satisfy a pass/fail criterion.

Because any single image of a scene may contain shimmer and noise, in operation, multiple images of a scene are obtained by both sensors 115 in rapid succession following a frame trigger. These “subframes” are then averaged or otherwise combined to produce a single final frame for each sensor 115. The subframe parameters and timing relative to the frame trigger can be programmable at the system level and can be used to reduce crosstalk between sensors. Programming may include subframe timing to achieve time multiplexing, and also frequency modulation of the carrier. Subframe averaging may increase the SNR, thereby improving system performance.

As indicated in FIG. 1, an external sync 150 for frame-level and, in some cases, subframe triggering may be provided to allow multiple cameras 100 to cover the same scene with safety guarantees, allowing the camera outputs to be interlaced. The frame-level and subframe triggering may use time-sequence multiplexing to avoid interference. One camera 100 may be designated as a primary that controls the overall timing of the cameras to ensure that only one is illuminating the scene at a time. This primary provides trigger signals to the individual cameras to indicate when they should acquire the next frame or subframe. Alternatively, all cameras 100 may receive the same trigger signal and respond individually without control by any other camera. Any signal-propagation delay caused by a camera's location of the camera within the workcell may be reflected in the illumination timing guardbands. The cameras 100 may be programmed to have unique timing IDs and corresponding illumination timing to ensure precise operation without interference or crosstalk.

Some aspects utilize a dark frame (i.e., an image of the scene without illumination) for real-time correction of ambient noise and sensor offset. Often a differential measurement technique that uses multiple subframe measurements to cancel out noise sources is effective. However, by using the dark subframe not only as a measurement of ambient levels but also as a measurement of inherent camera noise, the number of subframes required can be decreased, which increases the amount of signal available for each subframe.

As illustrated in FIG. 2, a pipeline architecture may be used to facilitate efficient subframe aggregation and processing as the next set of subframes is recorded. The architecture 200 representatively includes an FPGA 210, a pair of primary-secondary ToF sensors 215_{M}, 215_{S} (which may be substantially similar to those described with respect to FIG. 1), and a plurality of external DDR memory banks 217₁, 217₂ to support subframe aggregation from captured frame data. As subframes are captured by the sensors 215_{M}, 215_{S}, they follow a data path 222₁, 222₂, respectively, accumulating in the DDR memory banks 217 at a rate reflecting the difference between the rate of subframe capture and depth-compute processing.

Each data path 222 may have multiple DDR interfaces with ECC support to allow for simultaneous reading and writing of memory, but the two data paths 222 are independent. Each of the depth-compute pipelines 230₁, 230₂ (generally referred to, individually or collectively, as depth-compute pipelines 230) operates in a pipelined fashion such that, after each processing step, a new frame can be started as an earlier frame is completed and intermediate frames are stepwise advanced through the processing path. Data relevant to calibration (e.g., temperature data) may be acquired and passed alongside contemporaneous sensor data to the depth-compute pipelines 230, so that at each processing step, the depth computation is performed in accordance with environmental conditions prevailing when the frame was acquired.

The new images with depth information that emerge after each time step from the depth-compute pipelines are compared by the sensor comparison processing unit 235 as described above and output as Ethernet data. FIG. 2 shows that the Ethernet communication layer 240 can, if desired, be implemented outside the FPGA 210. The outgoing frame data may be supplied, via the Ethernet communication layer 240, to a 3D vision safety system as described, for example, in U.S. Pat. No. 11,543,798 issued on Jan. 3, 2023, the entire disclosure of which is hereby incorporated by reference. In some aspects, data from the primary and secondary pipelines 230₁, 230₂ is provided directly to the external computer vision system, so that the comparison takes place on the external system rather than within the FPGA 210.

As described in U.S. Pat. No. 11,543,798, 3D sensor data may be processed to facilitate detection and classification of objects in the monitored space, their velocities, and distances between them. Computation modules in the external computer vision process the depth images to generate and/or analyze the 3D volume. For example, the system may recognize hazards, e.g., as a person approaches controlled machinery such as a robot, the system issues commands to slow or stop the machinery, restarting it once the person has cleared the area. The computer vision system may also control sensor operation, e.g., triggering them in a sequential fashion so as to prevent crosstalk among the sensors.

In a typical deployment of the illustrated system 200, multiple 3D ToF cameras are mounted and fixed in place around the workspace or object to be measured or imaged (see for example, FIGS. 5 and 6). An initial calibration step is performed by a calibration module 242 (which may be part of the system 200 or implemented externally, e.g., as a stand-alone component) at each 3D ToF camera to correct for structured noise effects including temperature and optical distortions specific to the camera. The latter represent a baseline calibration and may involve intensity-only optical characterization of each focal distance, principal point and distortions and the determination of the spatial transform between the coordinate systems (orientations) of the sensors 215_{M}, 215_{S}.

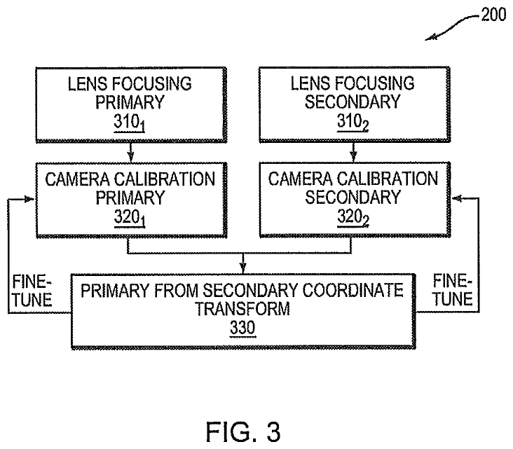

In greater detail, and with reference to FIG. 3, the objective of camera calibration is to characterize the optical performance of each of the sensors 215_{M}, 215_{S}, i.e., to measure the intrinsic parameters-focal distances (step 310), the coordinates of the principal point, and radial and tangential distortion coefficients (step 320). A 2D checkerboard target is registered by the primary and secondary sensors 215_{M}, 215_{S} in multiple (e.g., 20-30) spatial orientations and the resultant intensity images analyzed to derive the intrinsic parameters for each sensor 215. The system 200 may be mounted on a rotating platform so that the sensors 215_{M}, 215_{S} can be presented to the 2D checkerboard in different poses. In one implementation, 16 measurements, varying the pan and tilt, and hence the pose of the system 200 relative to the 2D checkerboard, are obtained with the 2D checkerboard at 1.4 m from the sensor, and nine measurements are obtained with the 2D checkerboard at 2 m distance.

Following this calibration step, the same images of the checkerboard used for calibration may be analyzed by conventional stereo calibration software that produces the rotational and translation components of the spatial transform. The checkerboard image obtained by the secondary sensor 215_{S} is transformed using this coordinate transform and the result is compared with the image obtained by the primary sensor 215_{M} (step 330). The result is used as input to the calibration process again as a fine-tuning. The procedure 300 is repeated until a desired level of convergence in the parameters (i.e., deviation between the transformed and observed image) is achieved.

Range calibration is employed to minimize error in the range value reported by each pixel of the sensors 215. For example, a range correction may be computed for every pixel for each of the raw data modes (various illumination patterns and illumination time windows) of the sensors 215. Most 3D cameras have an inherent property called fixed pattern phase noise (FPPN), which introduces a fixed offset value for the distance reported by each pixel. In order to make the system 200 report the correct distance, each sensor 215 is calibrated as herein described.

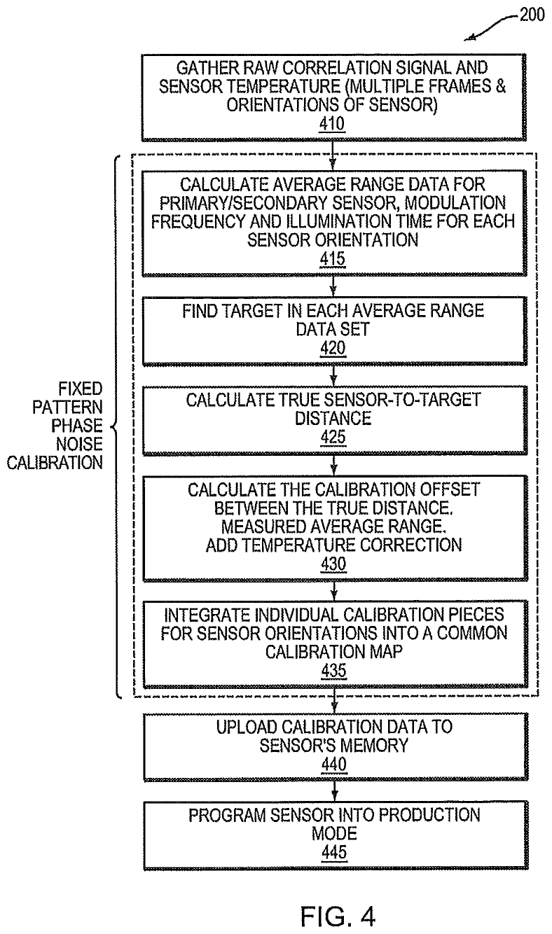

A representative secondary calibration procedure, which includes range calibration and adjustment for temperature, is illustrated within the broader calibration procedure 400 in FIG. 4. First, raw signal and sensor temperature data is acquired at different camera orientations (step 410). A matte white board may be used as a target to ensure uniform reflectivity and brightness. The system 200 is mounted on a rotating fixture that provides controlled angular movement in two dimensions (pan/tilt). The target is positioned at a fixed distance of 2-4 m from the fixture. The sensors 215 record range data for the target at different angles (e.g., 4 tilt positions and 11 pan positions) such that all the pixels of the sensors 215 can image the target and report the range data (steps 415, 420). The calibration routine calculates the geometrically correct range distance based on the known distance to the target (step 425), compares it to the measured one and calculates correction offset values (step 430), which are assembled into a combined calibration map (step 435) containing correction values for all measured distances to the target. A separate calibration map may be produced for each raw data mode of the sensors.

Other metadata may also be captured, such as the subframe expected background image, which may be used for real-time monitoring of camera measurement stability. Each camera 100 can frame or subframe trigger an exposure by varying illumination frequencies and illumination levels, including the dark level captured by the camera under no illumination. Through the external subframe external sync 150, multiple 3D ToF cameras can be triggered at different frequencies and illumination levels to minimize interference and lower the latency of all the 3D ToF cameras in the workcell. By coordinating the overall timing of the cameras (to ensure that only one is illuminating the scene at a time), typically by an external computer vision system as described above, latency between all the cameras can be reduced and acquisition frequency increased.

As noted, the range data produced by an image sensor is generally temperature dependent. In accordance with the present disclosure the dependency may be empirically approximated linearly and used to recalculate the range values as if they were produced at a fixed reference temperature, e.g., 25° C. (FIG. 4, step 430). During sensor calibration, the sensor's temperature may differ from the reference value of 25° C. due variability in the ambient temperature and also may vary during the steps of the calibration process. Hence it is desired to compensate for this effect during calibration as well as during operation.

The linear relationship may be given by

$$C ( {T}_{0} ) = {D}^{*} - D ( {T}_{C} ) + k \cdot ( {T}_{C} - {T}_{0} )$$

where C(T₀) is the FPPN calibration value to be stored on the EEPROM and used for the range correction at a reference temperature T₀ (e.g., 25° C.), T_{C} is the on-sensor temperature as actually measured by a thermometer within or close to the sensor 215 in the system (e.g., camera) 200, D* is the theoretically calculated true value of the range distance, D(T_{C}) is the range value directly calculated from the raw sensor data during the calibration at temperature T_{C}, and k is a coefficient whose value depends on the sensor and the modulation frequency mode and may be obtained empirically without undue experimentation. In some aspects, since this coefficient depends on the attributes of the sensor 215 and the modulation frequency employed, there are four different coefficients k, i.e., for the primary and secondary sensors 215_{M}, 215_{S} and for each of the two modulation frequencies. The additional term k·(T_{C}−T₀) is added when computing the FPPN calibration value C(T₀), i.e., the range offset. In particular, FPPN calibration involves gathering a number of frames for each angular orientation (pose) of the sensor. The range values for each frame are averaged, and the average range reading serves as D(T_{C}) in the equation above. Correspondingly, the on-sensor temperature is acquired for each frame, and these values are averaged to obtain a general temperature value T_{C} for the given pose. The process is repeated for each pose of the system 200.

The resulting calibration parameters (i.e., the lens parameters and calibration maps) are uploaded to a non-volatile programmable read-only memory (PROM) 245₁, 245₂ of each sensor 215 (step 440). Alternatively, the PROMs 245 may be more easily modified, e.g., as Flash memory. The calibration maps necessary for the correct range calculation are applied internally by the FPGA 210. After completion of the calibration (and, in some aspects, following a validation procedure that confirms the calibration on a benchmarking arrangement), the camera 200 is brought into production mode whereby it is made fully operational for customers (step 445).

Calibration can be adjusted not only for camera-specific performance differences but characterizing interference between cameras in a multiple-camera configuration. During initialization, one camera at a time illuminates the scene and other cameras determine how much signal is received. This procedure facilitates the creation of an interference matrix, which may be employed (e.g., by an external computer vision system as described above) to determine which cameras can illuminate at the same time. Alternatively, this approach can also be used to create a real-time correction similar to crosstalk correction techniques used for electronic signal transmission. In particular, multiple cameras may cooperate with each other (in, for example, an ad hoc network or with one camera designated as the primary and the others operating as secondaries) to sequentially cause each of the cameras to generate an output while the other cameras are illuminating their fields of view, and may share the resulting information to build up, and share, the interference matrix from the generated outputs. Alternatively (and more typically), these tasks may be performed by a supervisory controller (e.g., the external computer vision system) that operates all cameras.

The depth-compute pipeline utilizes these data along with the streaming frame data as well as data characterizing the sensor's fixed noise properties in computing depth and error as described above. When the camera 200 is powered up, the corresponding FPGA flash image is activated by the camera's operating system. During the initialization stage, the operating system causes calibration parameters and other data to be retrieved from the boot PROMs 245₁, 245₂ and copied into the relevant registers (e.g., camera characterization parameters) or into the DDR memory banks 217₁, 217₂ (e.g., calibration maps). Following initialization, the system 200 is switched into a “ready” state and is ready for UDP communication with external control devices.

In accordance with the present disclosure, the following data may be stored in the boot PROMs 245₁, 245₂; each data field may be protected against the errors on the communication channel using, for example, a cyclic redundancy check:
(a) Version of the boot file.
(b) Sensor hardware version, serial number and MAC address.
(c) Calibration version and calibration ID (may identify calibration location, calibration hardware, timestamp).
(d) Sensor-specific intrinsic parameters, radial and tangential distortions, temperature-correction coefficient and, if desired, a correction coefficient for ambient humidity.
(e) Data specifying primary from secondary coordinate transform: translational vector (three coordinates) and normalized quaternion that defines rotation (four coordinates).
(f) FPPN correction data, i.e., the calibration maps enabling the correct depth calculations by primary and secondary sensors for each combination of their modes of operation (modulation frequencies and illumination times).

Optionally:
(g) Fixed pattern noise (FPN) data characterizing dark noise.
(h) Harmonic correction table characterizing errors caused by the real modulation pattern deviating from the sinusoidal one. That is, calculating depth data from the measured phase delays relies on a model of emitting light having a sinusoidal modulation. In reality, the modulation pattern is closer to a square wave, and the difference introduces a so-called harmonic error that may be characterized by a harmonic correction table.

During run time, the depth-compute engine 230 accesses the calibration data in real time from DDR3 memory as needed. In particular, real-time recalibration adjusts, in a conventional fashion, for drift of operating parameters such as temperature or illumination levels during operation. Health and status monitoring information may also be sent after every frame of depth data, and may include elements such as temperatures, pipeline error codes, and FPGA processing latency margins as needed for real-time recalibration.

Data flows from each sensor 215 through a data reception path in the FPGA 210 and into the associated DDR 217. The data is stored in the DDR 217 at a subframe level. Once a depth-compute engine 230 recognizes that a full subframe has accumulated in the associated DDR 217, it starts pulling data therefrom. Those pixels flow through the depth-compute engine 230 and are stored back in the associated DDR 217 as single-frequency depth values. These contain ambiguous depth results that need to be resolved later in the pipeline via comparison. Accordingly, as soon as the first three or more subframes needed for calculating the first single-frequency result are available in the DDR 217, the associated depth-compute engine 230₁, 230₂ (see also 130₁, 130₂, in FIG. 1) will begin calculating the ambiguous depth on a pixelwise basis using those three subframes. While this is happening, the following three subframes for the second single-frequency result are loaded from sensor 215 into memory, and as subframe queues empty, they receive previously loaded data so that no processing cycles are wasted on fetches. Once the first single-frequency result is calculated and fully loaded into memory, the depth-compute engine will begin calculating the second single-frequency depth result in a similar fashion. Meanwhile the third set of subframes is loaded into memory.

However, rather than loading the second single-frequency depth result into memory as it is calculated, it is processed along with the first single-frequency depth result on a pixelwise basis to produce an unambiguous depth result. This result is then stored in memory as an intermediate value until it can be further compared to the second unambiguous depth result obtained from the third and fourth single-frequency depth results. This process is repeated until all the relevant subframes are processed. As a last step, all intermediate results are read from the DDR and final depth and intensity values are calculated.

An operating timer 250 (once again shown as an internal component for convenience, but which may be implemented externally) may be included to keep track of the hours of camera operation, periodically sending this data to the user via the communication layer 240. The calibration unit 242 may also receive this information to adjust operating parameters as the camera illumination system and other components age. Moreover, once the aging limit for VCSELs is reached, the timer 250 may produce an error condition to alert the user that maintenance is required.

The features described above address various possible failure modes of conventional 3D cameras or sensing systems, such as multiple exposures or common mode failures, enabling operation in safety-rated systems. The system may include additional features for safety-rated operation. One such feature is over/under monitoring of every voltage rail by a voltage monitor so that, if a failure condition is detected, the camera may be turned off immediately. Another is the use of a safety-rated protocol for data transmission between the different elements of the 3D ToF camera and the external environment, including the external sync. Broadly speaking, a safety-rated protocol will include some error checking to ensure that bad data does not get propagated through the system. It is possible to create a safety-rated protocol around a common protocol, such as UDP, which supports high bandwidths but is not inherently reliable. This is accomplished by adding features that effect a desired safety-rating, such as packet enumeration, CRC error detection, and frame ID tagging. These assure that the current depth frame is the correct depth frame for further downstream processing after the frame data is output from the camera.

A common failure mode of cameras with active optical sensors that depend on reflection, such as LIDAR and ToF cameras, is that they do not return any signal from surfaces that are insufficiently reflective, and/or when the angle of incidence between the sensors and the surface being detected is too shallow. This may lead to undesired failure because the level of the signal may be indistinguishable from the one measured if no obstacle is encountered. The sensor, in other words, will report an empty volume despite the possible presence of an obstacle.

For various reasons, on any given imaged frame, a small fraction of the pixels in a ToF image may provide an incorrect range or distance (the terms distance and range are used interchangeably herein) measurement or no range measurement at all. For non-safety applications, such incorrect pixels are typically not a major concern. However, for safety applications, an incorrect pixel could result in a condition that may be a hazard.

Many safety applications involve determining the nearest possible location of a person to a machine, such as an industrial robot, and sending an emergency stop signal to the machine if that person is too close. In such applications, failure to detect an object where there is, in reality, an object in the volume can create an undesirable situation in the case where the object is a human and there is machinery nearby operating such that the distance between the object and the machine is less than a predetermined protective separation distance.

This is why ISO standards for e.g., 2D LIDAR sensors have specifications for the minimum reflectivity of objects that must be detected; however, these reflectivity standards can be difficult to meet for some 3D sensor modalities such as ToF. In a representative workcell (such as those illustrated in FIGS. 5 and 6) there could be a multitude of objects with poor reflectivity, and modifying the objects or changing them to be reflective may not always be possible. It is desired that 3D ToF cameras be sufficiently reliable to generate a return signal under a wide variety of reflectivity conditions in the workcell.

U.S. Pat. Nos. 10,099,372, 10,899,007 and 11,279,039 provide a methodology (using two or more sensors that can sense a given volume) where if one sensor does not see a return, a second (or more) sensor can affirmatively receive a return from the same volume, confirming whether the space is actually empty or occupied.

A simpler approach (using a single sensor) to guarantee a return signal in order to meet safety-rated standards (such as for example, ISO 61496-3) is to increase the intensity of the illumination by using a more powerful light source, driving a lower power light source harder so it is a more powerful light source (i.e., increasing the power output of the lower power light source), using more lower power light sources in parallel, increasing the sensitivity of the light sensing element, and/or decreasing the field of view over which the light source is diffused to increase illumination power density, where, as noted herein, the light source may be a VCSEL laser source or any other suitable light source. But this generates its own set of issues that need to be addressed for the operation of the machinery in accordance with the applicable standards, such as those described herein.

Imaging distortions that are introduced by more powerful light sources involve the impact of the higher signal return on pixel-level saturation from the higher dynamic range and distortions on adjacent pixels from saturation. The present disclosure provides methods and techniques that may correct these issues.

In addition to pixels providing no range data due to insufficient return, a pixel may provide a range measurement that is incorrect. If an incorrect pixel results in an object being observed as further away from the machine than it actually is, the system may fail to send an emergency stop signal, which could result in an undesired situation or simply to unnecessary stops of the machine if the object is observed as closer to the machine than it actually is.

When using time of flight sensors for safety applications, it is typically desired to utilize various strategies for detecting and discarding invalid measurements. One strategy (as presented in U.S. Pat. Nos. 10,887,578 and 10,887,579) is to employ two redundant ToF imagers in the same camera and compare their results, where if the results from the two imagers agree the values can be used, if they disagree, they are to be discarded.

Discarding invalid measurements can result in unnecessarily conservative conclusions that lower productivity. For example, if a pixel is discarded, a solution would be to assume that the entire volume of space that would have been monitored by that pixel may be occupied. Especially when a ToF sensor is being used at relatively long range to monitor a large space, the volume monitored by a single pixel may be large enough to contain an entire person or at least a person's hand or arm. In this case, a single bad pixel could result in an undesired emergency stop.

In many cases where a pixel is flagged as invalid or suspect by one aspect of the system (such as the system 100 described herein), such as low intensity or a discrepancy with a second imager, additional elements of the sensor's data corresponding to secondary physical properties of the observed scene can be used to reconstruct a correct or conservative range value for that volume observed by that pixel. Such strategies are often desired to achieve a sufficiently low rate of both unnecessary stoppage of the machine and failure to stop the machine when desired for a target application.

Aspects of the present disclosure relate to systems and methods for three-dimensional ToF imaging of a large and diverse scene demanding reliability and accuracy for safety-rating purposes. Methods and techniques have been developed that may increase pixel-level range accuracy, accurately measure range for low-intensity pixels and pixels that receive illumination reflected from multiple surfaces and reduce or substantially eliminate various sources of range error.

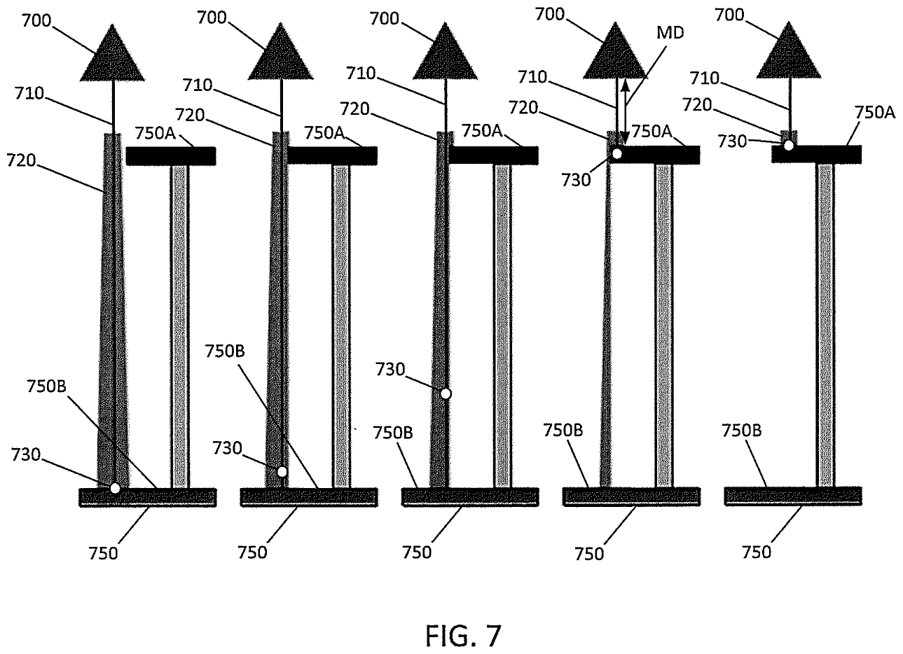

One common source of error in ToF measurements occurs when a single pixel observes reflected light from multiple surfaces. This can occur due to edges, such as where the field of the single pixel includes, for example, both the edge of a table and the floor beneath that table (or any other suitable edge of an object). In that case, some of the photons received by the pixel will have reflected off the table, while other photons will have reflected off the floor (see FIG. 7, where a world object 750 has a surface 750A that may be representative of the table and a surface 750B that may be representative of the floor). This typically results in a range (depth) measurement that is somewhere between the table (e.g., surface 750A) and the floor (e.g., surface 750B), a location where no object actually is. Another source of such errors is multipath, where some light received by a pixel reflects directly off a given surface (the primary path), while other light is reflected from that surface after bouncing off an intermediate angled surface (the secondary path), thus traveling a longer path and appearing further away. This will typically result in the measured range of the surface appearing to be further away than the surface actually is. Increasing the unambiguous range of a sensor by lowering the frequency is not ideal because lowering the frequency loses distance resolution (the higher the frequency, the better the distance resolution per phase).

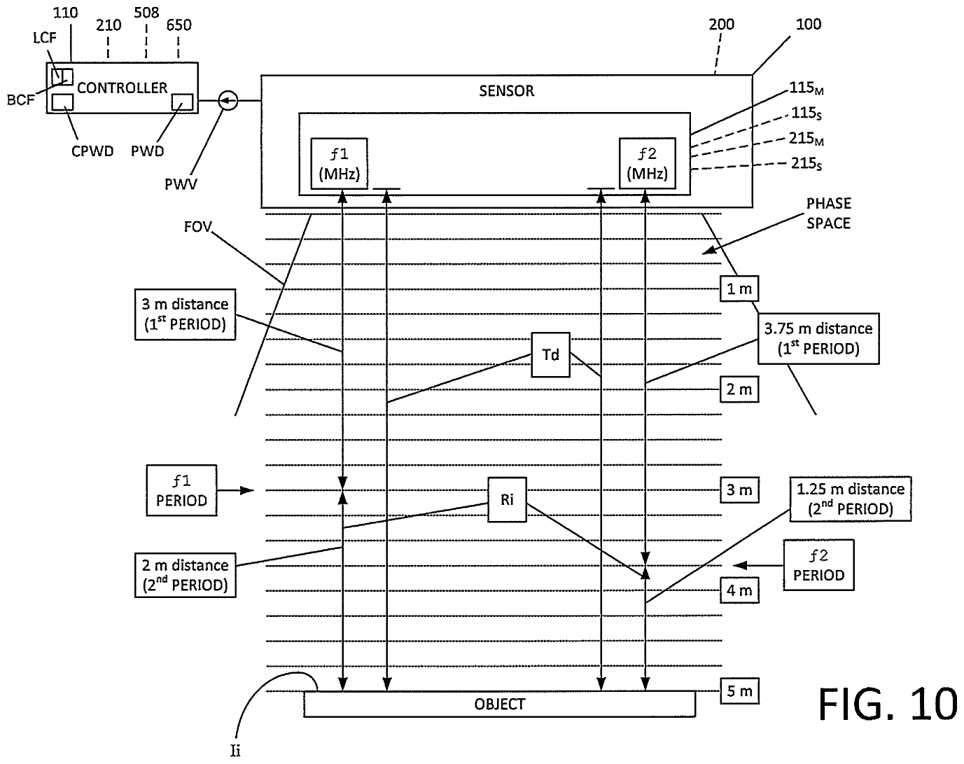

This reflected light issue can be mitigated by exploiting the periodic range ambiguity inherent in ToF imaging. This periodic range ambiguity in meters is defined by the ratio of 150/MF (i.e., the speed of light/MF/2), where MF is the modulation frequency of the sensor in MHz. For example, an object positioned at x meters from the sensor will be indistinguishable from an object positioned at an integer number of ambiguity distances plus x. One method for addressing this is to take measurements at two frequencies f₁, f₂, resulting in measurements with different range or distance ambiguities that can be used to disambiguate each other. For example, a sensor with a frequency f₁ of 50 MHz illumination will be able to measure a maximum of 3 m. Any distance greater than 3 m will result in a measurement between 0 and 3 m. In accordance with the present disclosure, and with reference to FIG. 10, a second imager frequency f₂ is used to extend the unambiguous range of the sensor 100. The second frequency f₂ has a different periodicity than the first frequency f₁ and allows for determining which period is correct. As an example, if pulses are emitted at a second frequency f₂ of 40 MHz, the ambiguity distance is 150/40=3.75 m and an object 5 meters from the sensor will be illuminated in synchronization with an object 1.25 meters away (since 1.25=5-3.75), hence introducing a distance error. Similarly, if the pulses are emitted at the first frequency f₁ of 50 MHz, the ambiguity distance is 150/50=3 m and the same 5 meter away object will have the same illumination as one 2 meters away (analogously to above, 2=5−3), hence introducing a distance error. However, if one measurement is taken at 40 MHz and one at 50 MHz, then we can calculate the consensus or true distance T_{d} and deduce that the object is 5 meters away. Of course, an object more than 15 meters away will still be illuminated in synchrony (as 15 is the integer number of both ambiguity distances: 3×5 and 3.75×4), but in many applications this can be disregarded as beyond the expected range.

Referring to FIGS. 1, 2, 5, 6, and 10 the present disclosure provides for an image processing system (such as illustrated in any one or more of FIGS. 1, 2, 5, 6, and 10) that includes at least two three-dimensional sensors 115_{M}, 115_{S}, 215_{M}, 215_{S} and a controller (which controller may be processor 110, FPGA 112, FPGA 210, and/or controller 512, noting that the image processing system controller may be separate from or integrated with the palletizer controller 650 or the robot controller 508). Each of the sensors 115_{M}, 115_{S}, 215_{M}, 215_{S} is for illuminating a corresponding field of view FOV of the sensor 115_{M}, 115_{S}, 215_{M}, 215_{S}, and generating an output array of pixelwise values PWV indicative of distances Rᵢ to illuminated objects in the field of view FOV. Each sensor 115_{M}, 115_{S}, 215_{M}, 215_{S} being configured to generate illumination at least at two different frequencies f₁, f₂ (in the example illustrated the two frequencies are 40 MHz and 50 MHz but again, any two suitable different frequencies may be employed) so that objects in the corresponding field of view FOV are illuminated at the two different frequencies.

The controller 110, 112, 210, 512 is communicably connected to the at least two three-dimensional sensors 115_{M}, 115_{S}, 215_{M}, 215_{S} to receive pixelwise data PWD from each sensor 115_{M}, 115_{S}, 215_{M}, 215_{S}. The pixelwise data PWD embodying intensity and distance information from the illuminated objects. The controller 110, 112, 210, 512 is configured (e.g., with any suitable non-transitory computer program code) so as disambiguate a distance to each of the illuminated objects, resolve error in the received pixelwise data PWD due to periodic distance ambiguity, and determine corrected pixelwise values CPWD indicative of true distance T_{d} via each sensor illumination at the at least two different frequencies f₁, f₂.

In the image processing system, the controller 110, 112, 210, 512 is configured: so as to disambiguate the distance and resolve error in the received pixelwise data PWD of each sensor 115_{M}, 115_{S}, 215_{M}, 215_{S}, and determine corrected pixelwise values CPWD of the output array of pixelwise values PWV of each sensor 115_{M}, 115_{S}, 215_{M}, 215_{S} indicative of the true distance T_{d}; and/or so that each sensor illumination at the at least two different frequencies f₁, f₂ describes a phase space in the corresponding field of view FOV that characterizes the relationship (within the corresponding field of view FOV) of different measured intensities (Iᵢ) and corresponding measured distances/ranges (Rᵢ) (or measured distances from the sensor 115_{M}, 115_{S}, 215_{M}, 215_{S} or any suitable reference datum/origin from which the distance is measured), of each object embodied in the pixelwise data PWD registered (e.g., recorded in any suitable memory) by the controller 110, 112, 210, 512 at the least two different frequencies f₁, f₂. The phase space relationship is programmed in the controller 110, 112, 210, 512 and the phase space relationship characterizes the relation between differences in the measured intensities (ΔI_{i,i+1}) and in differences of the measured distances (ΔR_{i,i+1}) corresponding to the measured intensities (Iᵢ) in the pixelwise data PWD.

In the image processing system the controller 110, 112, 210, 512 is programmed to one or more of: identify (or quantify) discrepancies in measured distances (Rᵢ) from the measured intensities (Iᵢ), the differences in the measured intensities (Iᵢ), the measured distances (Rᵢ), and the differences of the measured distances (ΔR_{i,i+1}) and calculate a distance error in the measured distance (Rᵢ); and determine a true distance T_{d} value from the measured distance (Rᵢ) and distance error.

In practice, the two intensity and range (depth/distance) measurements at the two different frequencies f₁, f₂ will differ slightly because of different responses at those frequencies f₁, f₂ to secondary sources of error such as light reflecting from two or more surfaces (multipath and edge effects) and harmonic distortion resulting from the fact that such sensors typically emit light in a square wave rather than a true sine wave. These secondary differences can be employed to further reduce error in the resulting combined measurement.

This can be accomplished as follows. Consider two sets of intensity and range measurements, Iₐ, Rₐ, I_{b}, and R_{b}. The discrepancy between the intensity values and range values can be respectively denoted as (Iᵣₐₜᵢₒ=Iₐ/I_{b}) and (ΔR). Theoretical calculations developed in accordance with the present disclosure provide a phase space where discrepancies Iᵣₐₜᵢₒ and ΔR define the range measurement error and the relative intensity of direct optical paths and multi-path optical paths. This phase space produces a 1:1 correspondence between the Iᵣₐₜᵢₒ and ΔR values and the length and intensity of the multi-path optical path(s). Thus, given these discrepancies, it is possible to compute exactly how the data is affected by multi-path optical path(s), and correct for it. This computation describes precisely how multi-path optical path(s) effects affect the data, allowing the system 100 to directly correct these and produce more accurate data.

In an ideal scenario, the intensity and unambiguous range between the two frequencies f₁, f₂ agree identically. However, in the presence of multi-path optical paths, there may be an error between the two ranges or distances (each range being measured at a respective one of the two frequencies f₁, f₂) and an error between the two intensities. The source of the multi-path optical paths (intensity and range) will change the two error signals and hence, determine the error signal, or error er(Iₐ, I_{b}), er(Rₐ, R_{b}) in the measured signals (Iₐ, Rₐ), (I_{b}, R_{b}) for each corresponding frequency f₁, f₂, and identify the true range or distance T_{d} of the object.

Accordingly, the present disclosure proposes a method where all four pieces of measured information (Iₐ, Rₐ), (I_{b}, R_{b}), the intensity average (Iₐ+I_{b})/2, range average (Rₐ+R_{b})/2, intensity difference (Iₐ−I_{b}), and range difference (Rₐ−R_{b}) are used to estimate four unknowns (true range of a target, intensity of the target, multipath signal range, and intensity). Linear algebra multivariable equation methods or nonlinear multivariate inverse methods may be employed to extract the true range and intensity of the target from the intensity and range average between the two frequencies and the intensity and range difference between the two frequencies.

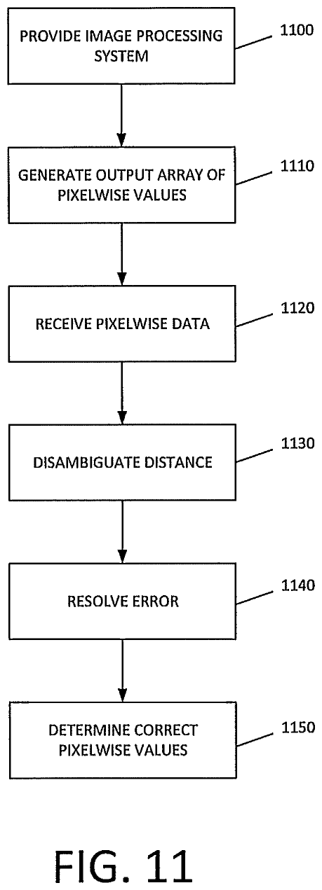

Referring to FIGS. 1, 2, 5, 6, 10, and 11, the present disclosure provides for a method for identifying a true distance of an object. The method includes providing an image processing system (such as illustrated in any one or more of FIGS. 1, 2, 5, 6, and 10) (FIG. 11, Block 1100) having at least two three-dimensional sensors 115_{M}, 115_{S}, 215_{M}, 215_{S}, each sensor 115_{M}, 115_{S}, 215_{M}, 215_{S} for illuminating a corresponding field of view FOV of the sensor 115_{M}, 115_{S}, 215_{M}, 215_{S}. An output array of pixelwise values PWV is generated (FIG. 11, Block 1110) with each of the at least two three-dimensional sensors 115_{M}, 115_{S}, 215_{M}, 215_{S}, where the output array of pixelwise values PWV is indicative of distances Rᵢ to illuminated objects in the field of view FOV. Each sensor 115_{M}, 115_{S}, 215_{M}, 215_{S} is configured to generate illumination at least at two different frequencies f₁, f₂ (in the example illustrated the two frequencies are 40 MHz and 50 MHz but again, any two suitable different frequencies may be employed) so that objects in the corresponding field of view FOV are illuminated at the two different frequencies f₁, f₂. The controller (which controller may be processor 110, FPGA 112, FPGA 210, and/or controller 512 and communicably connected to the at least two three-dimensional sensors) receives pixelwise data PWD (FIG. 11, Block 1120) from each sensor 115_{M}, 115_{S}, 215_{M}, 215_{S}, where the pixelwise data PWD embodies intensity and distance information from the illuminated objects. The controller 110, 112, 210, 512 disambiguates a distance to each of the illuminated objects (FIG. 11, Block 1130), resolves error in the received pixelwise data PWD due to periodic range ambiguity (FIG. 11, Block 1140), and determines corrected pixelwise values CPWD (FIG. 11, Block 1150) indicative of true distance T_{d} via each sensor illumination at the at least two different frequencies f₁, f₂.

The method may include one or more of the following, in any suitable combination thereof and/or in combination with any of the features described herein: with the controller 110, 112, 210, 512, disambiguating the distance and resolve error in the received pixelwise data PWD of each sensor 115_{M}, 115_{S}, 215_{M}, 215_{S}, and determine corrected pixelwise values CPWD of the output array of pixelwise values PWV of each sensor 115_{M}, 115_{S}, 215_{M}, 215_{S} indicative of the true distance T_{d}; the controller 110, 112, 210, 512 is configured so that each sensor illumination at the at least two different frequencies f₁, f₂ describes a phase space in the corresponding field of view FOV that characterizes the relationship (within the corresponding field of view FOV) of different measured intensities (Iᵢ) and corresponding measured distances/ranges (Rᵢ) (or measured distances from the sensor 115_{M}, 115_{S}, 215_{M}, 215_{S} or any suitable reference datum/origin from which the distance is measured), of each object embodied in the pixelwise data PWD registered (e.g., recorded in any suitable memory) by the controller 110, 112, 210, 512 at the least two different frequencies f₁, f₂; the phase space relationship is programmed in the controller 110, 210, 512 and the phase space relationship characterizes the relation between differences in the measured intensities (ΔI_{i,i+1}) and in differences of the measured distances (ΔR_{i,i+1}) corresponding to the measured intensities (I) in the pixelwise data PWD; with the controller, identifying discrepancies in measured ranges (Rᵢ) from the measured intensities (Iᵢ), the differences in the measured intensities (ΔI_{i,i+1}), the measured distances (Rᵢ), and the differences of the measured distances (ΔR_{i,i+1}), and calculating a distance error in the measured distance (Rᵢ); and determining, with the controller 110, 112, 210, 512 a true distance T_{d} value from the measured distance (Rᵢ) and distance error.

As mentioned above, one cause of invalid measurements is a pixel whose intensity is too low to provide a valid range measurement. This is particularly likely to occur with small, low reflectivity features. In a camera that includes at least two imagers (a primary imager and a secondary imager) such as the one described in U.S. Pat. Nos. 10,887,578 and 10,887,579, the intensity values of the pixels from the primary imager and the secondary imager corresponding to a particular point can be used to replace or estimate the distance to the camera by using stereo vision techniques. Small, low reflectivity features in a high frequency neighborhood are particularly likely to provide valid stereo information as they would stand out in an otherwise higher reflectivity image.

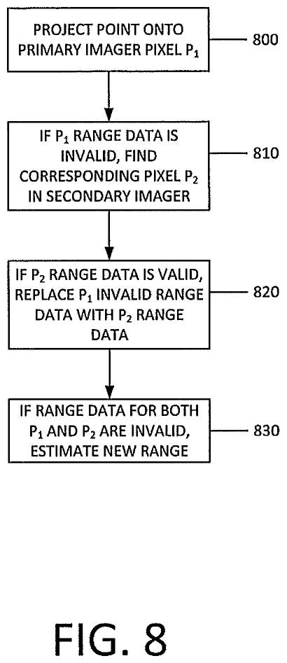

The replacement approach would work like this: A point O projects onto (without loss of generality) a primary imager's pixel P₁ (FIG. 8, Block 800). If P₁'s range is invalid, its intensity neighborhood can be used to find a corresponding pixel P₂ with a similar neighborhood in the secondary imager (FIG. 8, Block 810). A naive approach to search for P₂ would involve the whole intensity image of the secondary imager and would be prone to false positives and computationally unattractive. Fortunately, the search time can be drastically reduced and its accuracy increased using epipolar geometry constraints. The epipolar constraint makes the search computationally attractive and more accurate by restricting the search domain for P₂ to be the epipolar line instead of the whole image. If P₂'s range data is valid, it may replace P₁'s invalid range (FIG. 8, Block 820).

The estimation approach would work like this: If P₁ and P₂ both have invalid range data, a new range can be estimated (FIG. 8, Block 800) by using their disparity value. The disparity is defined as the distance between P₁ and P₂ in the pixel coordinate frame. The disparity magnitude of two corresponding pixels in a stereo system depends on the range of the point O. This is because the imagers are spatially separated by a baseline. Due to an optical phenomenon known as parallax, in a stereo system with pinhole imagers the disparity of O will be directly proportional to its range, i.e., it will appear shifted more in the secondary imager with respect to the primary imager if it is closer to the camera and vice-versa.

This use of stereo depth from intensity increases the signal to noise ratio. The stereo depth signal can be considered a third source of range in addition to the two direct versions of range provided by each of the ToF imagers/sensors 115_{M}, 115_{S} (FIG. 1, see also 215_{M}, 215_{S} in FIG. 2) in the camera 100. If the reflected intensity to the ToF sensor 115_{M}, 115_{S} (FIG. 1, see also 215_{M}, 215_{S} in FIG. 2) is too low, the two direct sources of range will provide a range, but the error bars will be too high to use for safety. It is noted that the error bars provide a measure of the noise from the true measurement provided by the sensor 115_{M}, 115_{S} (FIG. 1, see also 215_{M}, 215_{S} in FIG. 2). The sensor 115_{M}, 115_{S} (FIG. 1, see also 215_{M}, 215_{S} in FIG. 2) itself has an error bar given the intrinsic characteristic of the sensor 115_{M}, 115_{S} (FIG. 1, see also 215_{M}, 215_{S} in FIG. 2), and that error bar is determined by the sensor characteristics and the sensor calibration process (which calibration is performed such as at manufacture of the sensor prior to deployment of the sensor). There may also be an error bar from the measurement provided by the sensor 115_{M}, 115_{S} (FIG. 1, see also 215_{M}, 215_{S} in FIG. 2). For safety applications, standards such as ISO 10218-1, ISO 13855, and IEC 61496 provide a way to calculate an application-specific maximum error on the sensor measurements, as if the sensor measurement has more than this prescribed maximum error, the measured distance will be greater than the allowed noise in the sensor measurement making the sensor insufficient to be used for safety. The stereo signal may be employed as a third source of truth confirmation to reduce the uncertainty further. If that reduction of uncertainty is sufficient (per, e.g., the ISO 10218-1 standard), then it can be used for safety.

Referring to FIGS. 1, 2, 5, 6, 10, and 12, the present disclosure provides for an image processing system (such as those described herein) having at least two three-dimensional sensors 115_{M}, 115_{S} (FIG. 1, see also 215_{M}, 215_{S} in FIG. 2) and a controller (e.g., such as one or more of processor 110, FPGS 112, FPGA 210, and/or controller 512). Each of the sensors 115_{M}, 115_{S} (FIG. 1, see also 215_{M}, 215_{S} in FIG. 2) illuminate a corresponding field of view FOV1, FOV2 of the sensor 115_{M}, 115_{S} (FIG. 1, see also 215_{M}, 215_{S} in FIG. 2), and generate an output array of pixelwise values PWV indicative of distances to illuminated objects in the field of view FOV1, FOV2. The at least two three-dimensional sensors 115_{M}, 115_{S} (FIG. 1, see also 215_{M}, 215_{S} in FIG. 2) are disposed to generate binocular images BM of the illuminated objects in the field of view FOV1, FOV2 (where, e.g., the illuminated objects being within an overlapping portion of the fields of view FOV1, FOV2). The controller 110, 112, 210, 512 is communicably connected to the at least two three-dimensional sensors 115_{M}, 115_{S} (FIG. 1, see also 215_{M}, 215_{S} in FIG. 2) to receive pixelwise data PWD from each sensor 115_{M}, 115_{S} (FIG. 1, see also 215_{M}, 215_{S} in FIG. 2) so as to register (e.g., record in any suitable memory) the binocular images BM and is configured (e.g., with any suitable non-transitory computer program code) to effect stereo matching from the binocular images BM resolving a pixelwise distance SD of the illuminated object, which pixelwise distance SD resolved from the binocular images BM corresponds to at least one pixel of the output array of pixelwise values PWV of each three-dimensional sensor 115_{M}, 115_{S} (FIG. 1, see also 215_{M}, 215_{S} in FIG. 2). The controller 110, 112, 210, 512 is configured (e.g., with any suitable non-transitory computer program code) to validate an uncertain pixelwise value of the at least one pixel of the output array of pixelwise values PWV of one of the at least two three-dimensional sensors 115_{M}, 115_{S} (FIG. 1, see also 215_{M}, 215_{S} in FIG. 2).

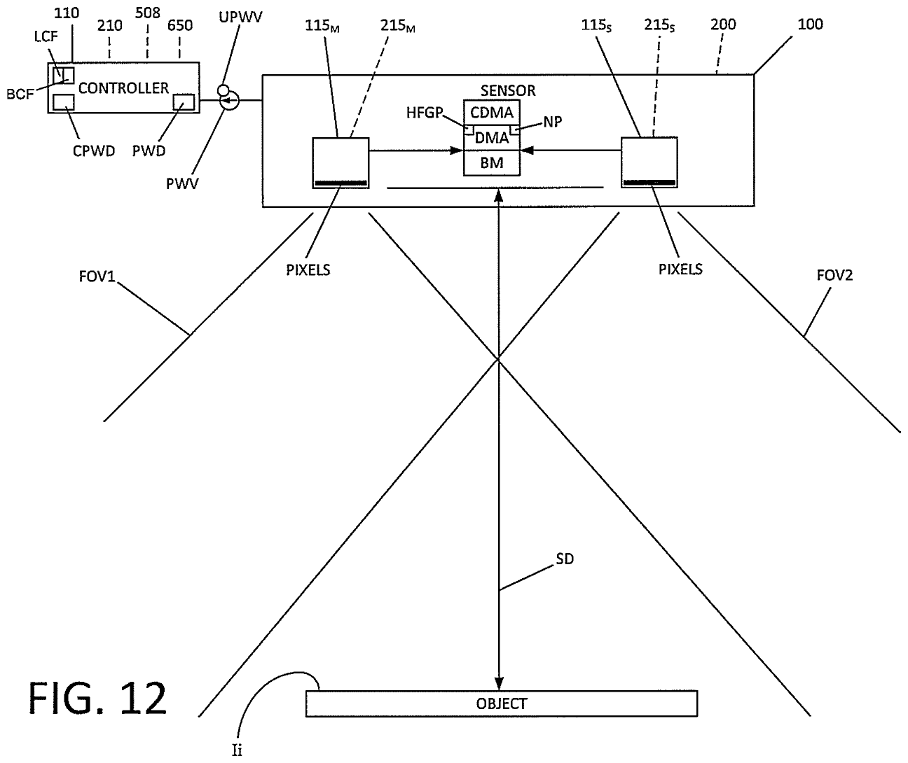

In FIG. 12 the pixelwise distance SD resolved from binocular images BM may one or more of: form a third measure of confidence relative to the pixelwise values of the output array of pixelwise values PWV; and be determined substantially simultaneously with obtaining the pixelwise values of the output array of pixelwise values PWV. Each of the at least two three-dimensional sensors 115_{M}, 115_{S} (FIG. 1, see also 215_{M}, 215_{S} in FIG. 2) may be a ToF sensor and the pixelwise values are obtained from ToF data of the sensor 115_{M}, 115_{S} (FIG. 1, see also 215_{M}, 215_{S} in FIG. 2). The controller 110, 112, 210, 512 is configured (e.g., with any suitable non-transitory computer program code) so as to provide the comparison unit 135 (FIG. 1), 235 (FIG. 2) with the validated pixelwise value of the sensor 115_{M}, 115_{S} (FIG. 1, see also 215_{M}, 215_{S} in FIG. 2) validated from the binocular vision.

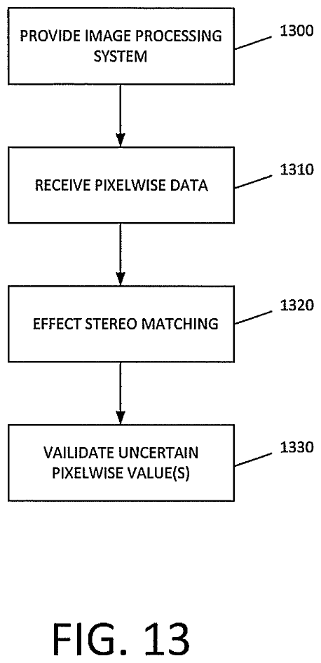

The present disclosure provides for a method of validating uncertain pixelwise value(s) of at least one pixel of an output array of pixelwise values of at least one of the sensors 115_{M}, 115_{S} (FIG. 1, see also 215_{M}, 215_{S} in FIG. 2). For example, referring to FIGS. 1, 2, 5, 6, 10, 12, and 13, the method includes providing an image processing system (such as those described herein) (FIG. 13, Block 1300) having at least two three-dimensional sensors 115_{M}, 115_{S} (FIG. 1, see also 215_{M}, 215_{S} in FIG. 2), each of the sensors 115_{M}, 115_{S} (FIG. 1, see also 215_{M}, 215_{S} in FIG. 2) being for illuminating a corresponding field of view FOV₁, FOV₂ of the sensor 115_{M}, 115_{S} (FIG. 1, see also 215_{M}, 215_{S} in FIG. 2), and generating an output array of pixelwise values PWV indicative of distances to illuminated objects in the field of view FOV₁, FOV₂. The at least two three-dimensional sensors 115_{M}, 115_{S} (FIG. 1, see also 215_{M}, 215_{S} in FIG. 2) are disposed to generate binocular images BM of the illuminated objects in the field of view FOV₁, FOV₂ (where, e.g., the illuminated objects being within an overlapping portion of the fields of view FOV₁, FOV₂). The controller (e.g., such as one or more of processor 110, FPGA 112, FPGA 210, and/or controller 512, which controller is communicably connected to the sensors 115_{M}, 115_{S} (FIG. 1, see also 215_{M}, 215_{S} in FIG. 2)) receives pixelwise data PWD (FIG. 13, Block 1310) from each sensor 115_{M}, 115_{S} (FIG. 1, see also 215_{M}, 215_{S} in FIG. 2) so as to register (e.g., record in any suitable memory) the binocular images BM. The controller 110, 112, 210, 512 effects stereo matching (FIG. 13, Block 1320) from the binocular images BM resolving a pixelwise distance SD of the illuminated object, which pixelwise distance SD resolved from binocular images BM corresponds to at least one pixel of the output array of pixelwise values PWV of each three-dimensional sensor 115_{M}, 115_{S} (FIG. 1, see also 215_{M}, 215_{S} in FIG. 2). The controller 110, 112, 210, 512 validates an uncertain pixelwise value(s) UPWV (FIG. 13, Block 1330) of the at least one pixel of the output array of pixelwise values PWV of one of the at least two three-dimensional sensors 115_{M}, 115_{S} (FIG. 1, see also 215_{M}, 215_{S} in FIG. 2).

The method includes one or more of the following, in any suitable combination thereof and/or in any suitable combination with the features described herein: the pixelwise distance SD resolved from binocular images BM forms a third measure of confidence relative to the pixelwise values of the output array of pixelwise values PWV; the pixelwise distance SD resolved from binocular images BM is determined substantially simultaneously with obtaining the pixelwise values of the output array of pixelwise values PWV; each of the at least two three-dimensional sensors 115_{M}, 115_{S} (FIG. 1, see also 215_{M}, 215_{S} in FIG. 2) may be a ToF sensor and the pixelwise values are obtained from ToF data of the sensor 115_{M}, 115_{S} (FIG. 1, see also 215_{M}, 215_{S} in FIG. 2); and the controller 110, 210, 512 is configured (e.g., with any suitable non-transitory computer program code) so as to provide the comparison unit 135 (FIG. 1), 235 (FIG. 2) with the validated pixelwise value of the sensor 115_{M}, 115_{S} (FIG. 1, see also 215_{M}, 215_{S} in FIG. 2) validated from the binocular vision.

Another source of invalid pixels are edge effects. Edge effects occur when a particular pixel or group of pixels is simultaneously imaging surfaces of materially different depths, where the depth signal from that pixel or group of pixels is effectively the “average” of both depths (see FIG. 7). As a result, the depth information from that pixel is not reliable, and cannot be used as-is for safety imaging. Such pixels are sometimes referred to as Flying Edge Pixels, high frequency gradient pixels or high spatial frequency pixels (such pixels will be referred to herein as high frequency gradient pixels HFGP). In FIG. 7, an exaggerated illustration of the edge effect is shown. The sensor (such as a ToF sensor/camera) is indicated by reference numeral 700, the pixel ray is indicated by reference numeral 710, the pixel frustum is indicated by reference numeral 720, the estimated (by integration) range is indicated by the circle identified by reference numeral 730, and world objects are indicated by the reference numeral 750 (the world object 750 having surfaces 750A, 750B for exemplary purposes only). In FIG. 7, from leftmost to rightmost, the images represent no edge effect (leftmost image) and edge effects for increasing edge intrusions (middle three images) inside the pixel frustum 720 causing high frequency gradient pixels HFGP.

In particular, high frequency gradient pixels HFGP can result in the appearance of objects where no object exists, which may result in false positives. However, those objects cannot simply be ignored because the actual location of the surfaces 750A, 750B that caused those reflections could represent a potential hazard.

Edge effects are worsened the further away the return surface 750A, 750B is. The higher the cameras 100 are mounted the higher the probability of edge effects, and also the lower the probability of other cameras 100 overlapping and covering for the fixed effects error. Hence longer-range cameras, such as those with high illumination, are likely to have worsened edge effects. Using a single camera also prevents the use of other sensors to correct the edge effects. However, it is possible to identify a range value for high frequency gradient pixels HFGP that can be used for safety.

Referring to FIGS. 7 and 12, an algorithm based on edge detection using any suitable edge detector (including, but not limited to, the Sobel Kernel) can be used in the identification of potential high frequency gradient pixels HFGP. The high frequency gradient pixel phenomenon occurs on edges in the imaged space, such as steps or the edge of a table (see, e.g., surface 750A). Hence, search for high frequency gradient pixels HFGP should focus on pixels that are imaging an edge, which have a high gradient by definition. The gradient of an image can be found by convolving the range image with a differential kernel such as the Sobel Kernel. Once identified, the neighborhood of that pixel can be searched to identify the neighbor pixel NP with the minimum range value, which represents the surface adjacent to the pixel that is closest to the sensor. That minimum value then represents the closest to the sensor that the high frequency gradient pixel HFGP could be. Therefore, the system can conclude that the space between the minimum range value and the sensor are empty, and values behind that range value are unknown. In many cases, this is sufficient to eliminate false positives caused by high frequency gradient pixels HFGP. However, distinguishing a valid pixel from a high frequency gradient pixels HFGP becomes a big challenge when the edge is very steep with respect to the camera 100. As a result, a valid edge pixel may be misclassified as a high frequency gradient pixel HFGP and not marked as occupied.

The spot size imaged by the pixel gets larger as the return surface 750A, 750B distance increases, hence the high frequency gradient pixel analysis done by the depth-compute engine 130 has to account for the distance to the return and to the spot size. The gradient calculation is performed in real time, requiring computation cycles from the imaging computer or processing unit 110.

The present disclosure may employ a calibration step to determine the edge effect correction as a function of distance. Hence, the correction for spot size is not done in real time, but using a lookup table LUP (see FIG. 1) provided by the calibration step. This is particularly useful when using a single high-illumination camera with a long imaging range, where edge effects are more pronounced, and it is not possible to use other cameras 100 to correct for the edge effect.

Still referring to FIGS. 7 and 12, the present disclosure provides for an image processing system (such as those described herein) that includes at least two three-dimensional sensors 115_{M}, 115_{S}, 215_{M}, 215_{S} and a controller (which controller may be processor 110, FPGA 112, FPGA 210, and/or controller 512). Each of the sensors 115_{M}, 115_{S}, 215_{M}, 215_{S} is for illuminating a corresponding field of view FOV of the sensor 115_{M}, 115_{S}, 215_{M}, 215_{S}, and generating an output array of pixelwise values PWV indicative of distances Rᵢ (see also FIG. 10) to illuminated objects in the field of view FOV. The controller 110, 112, 210, 512 is communicably connected to the at least two three-dimensional sensors 115_{M}, 115_{S}, 215_{M}, 215_{S} to receive pixelwise data PWD from each sensor 115_{M}, 115_{S}, 215_{M}, 215_{S} so as to register the output array of pixelwise values PWV as a measured depth map array DMA of the illuminated objects. The controller 110, 112, 210, 512 is configured to search for and find high frequency gradient pixels HFGP within the depth map array DMA in substantially real time. The controller 110, 112, 210, 512 is further configured to identify a neighbor pixel NP, to each high frequency gradient pixel HFGP within the depth map array DMA, with a value indicating a minimum distance to the illuminated objects and set the minimum distance as a true minimum distance to the illuminated objects.

The controller 110, 112, 210, 512 is programmed with a look up table LUP (see FIG. 1) of edge effect correction factors as a function of distance described by calibration data characterizing pixelwise response to edge effects as a function of distance for each sensor 115_{M}, 115_{S}, 215_{M}, 215_{S}. The controller 110, 112, 210, 512 finds the high frequency gradient pixels HFGP within the depth map array DMA substantially in real time based on convolving the depth map array DMA with an edge detector and application of the edge effect correction factors from the look up table LUP.

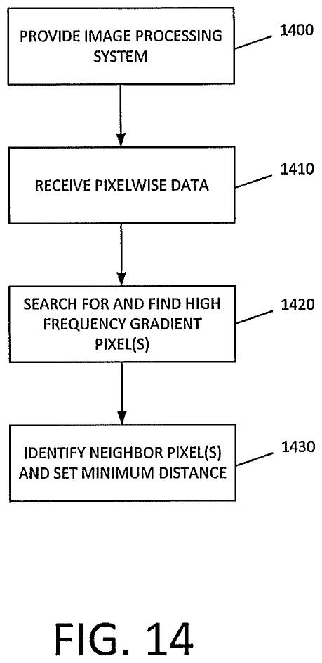

In accordance with the present disclosure, and referring to FIGS. 7, 10, 12, and 14, an exemplary method to identify and correct for high frequency gradient pixels HFGP is provided. The method includes providing an image processing system (such as those described herein) (FIG. 14, Block 1400) having at least two three-dimensional sensors 115_{M}, 115_{S}, 215_{M}, 215_{S}, each sensor 115_{M}, 115_{S}, 215_{M}, 215_{S} for illuminating a corresponding field of view FOV of the sensor 115_{M}, 115_{S}, 215_{M}, 215_{S}, and generating an output array of pixelwise values PWV indicative of distances Rᵢ to illuminated objects in the field of view FOV. The controller (which controller may be processor 110, FPGA 112, FPGA 210, and/or controller 512 and communicably connected to the at least two three-dimensional sensors) receives pixelwise data PWD (FIG. 14, Block 1410) from each sensor 115_{M}, 115_{S}, 215_{M}, 215_{S} so as to register (e.g., record in any suitable memory) the output array of pixelwise values PWV as a measured depth map array DMA of the illuminated objects. The controller 110, 112, 210, 512 searched for and finds high frequency gradient pixels HFGP (FIG. 14, Block 1420) within the depth map array DMA in substantially real time. The controller 110, 112, 210, 512 identifies a neighbor pixel NP, to each high frequency gradient pixel HFGP within the depth map array DMA, with a value indicating a minimum distance MD (see FIG. 7) to the illuminated objects and setting the minimum distance MD as a true minimum distance to the illuminated objects (FIG. 14, Block 1430).

In the method, the controller 110, 112, 210, 512 is programmed with a look up table LUP (see FIG. 1) of edge effect correction factors as a function of distance described by calibration data characterizing pixelwise response to edge effects as a function of distance for each sensor 115_{M}, 115_{S}, 215_{M}, 215_{S}. In the method, the controller 110, 112, 210, 512 finds the high frequency gradient pixels HFGP within the depth map array DMA substantially in real time based on convolving the depth map array DMA with an edge detector and application of the edge effect correction factors from the look up table LUP.

Another source of error is associated with dynamic range. Dynamic range refers to brighter, higher reflectivity surfaces resulting in a slightly different range error than lower reflectivity surfaces at the same distance due to non-linearities in sensor components. This is because sensors typically have a slightly non-linear relationship between the number of received photons and the measured intensity. For example, doubling the illumination of a low-reflectivity surface may only cause a 1.9× increase in the measured reflectance, due to imperfections in the sensor hardware.

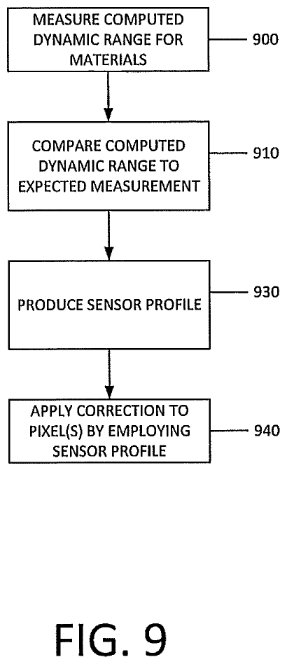

This dynamic range effect is expected to be the same for each pixel in the camera 100. As such, this error can be characterized by measuring the computed dynamic range for materials of diverse reflected intensities during a calibration process performed on each sensor/camera 100 at manufacturing time (FIG. 9, Block 900). By comparing this result to the expected measurement (FIG. 9, Block 910), a profile for the sensor/camera 100 may be produced or otherwise provided (FIG. 9, Block 920). By using the intensity data, we can use this profile during operation to apply a correction to each pixel (FIG. 9, Block 940). This linearization calibration may be employed (e.g., in any suitable combinations) with the calibrations/calibration data described herein. In addition to the dark frame noise, linearization characteristics may be computed and stored (e.g., in any suitable memory) by processing unit 110.

Referring to FIGS. 1, 2, 5, 6, 10, and 12, the present disclosure provides for an image processing system (such as those described herein) that includes at least one three-dimensional sensors 115_{M}, 115_{S}, 215_{M}, 215_{S} and a controller (which controller may be processor 110, FPGA 112, FPGA 210, and/or controller 512). The at least one three-dimensional sensor 115_{M}, 115_{S}, 215_{M}, 215_{S} is for illuminating a corresponding field of view FOV of the sensor 115_{M}, 115_{S}, 215_{M}, 215_{S}, and generating an output array of pixelwise values PWV indicative of distances Rᵢ (see also FIG. 10) to illuminated objects in the field of view FOV. The controller 110, 112, 210, 512 is communicably connected to the at least one three-dimensional sensor 115_{M}, 115_{S}, 215_{M}, 215_{S} to effect output from the at least one three-dimensional sensor 115_{M}, 115_{S}, 215_{M}, 215_{S} of a successive output arrays of pixelwise values PWV, and to receive pixelwise data PWD from the at least one three-dimensional sensor 115_{M}, 115_{S}, 215_{M}, 215_{S} so as to register (e.g., record in any suitable memory) each of the successive output arrays of pixelwise values PWV. The controller 110, 112, 210, 512 is programmed with a correction factor LCF (see FIGS. 10 and 12) describing a pixelwise linearized response of the at least one three-dimensional sensor 115_{M}, 115_{S}, 215_{M}, 215_{S} to intensity variances characterized by calibration data of calibration fields of different reflection intensities, other than dark frame illumination (the dark frame illumination effecting capture of only the random electronic thermal noise from a camera sensor). The controller 110, 112, 210, 512 is configured to correct in real time, with the correction factor LCF, the pixelwise data PWD of each of the successive output arrays of pixelwise values PWV and form a succession of corrected depth map arrays CDMA, substantially invariant to different intensities of the illuminated objects in the field of view FOV. The at least one three-dimensional sensor 115_{M}, 115_{S}, 215_{M}, 215_{S} may be a ToF sensor. The pixelwise values PWV may be obtained from ToF data of the ToF sensor.

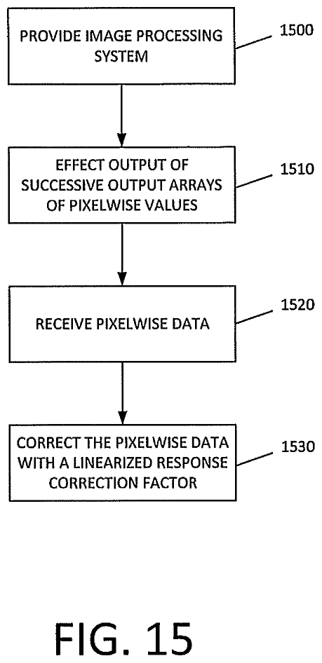

Referring to FIGS. 1, 2, 5, 6, 10, 12, and 15, the present disclosure provides for a method of correcting pixelwise data. The method includes providing an image processing system (such as those described herein) (FIG. 15, Block 1500) including at least one three-dimensional sensor 115_{M}, 115_{S}, 215_{M}, 215_{S} for illuminating a corresponding field of view FOV of the sensor 115_{M}, 115_{S}, 215_{M}, 215_{S}, and generating an output array of pixelwise values PWV indicative of distances Rᵢ(see also FIG. 10) to illuminated objects in the field of view FOV. The controller 110, 112, 210, 512 is communicably connected to the at least one three-dimensional sensor 115_{M}, 115_{S}, 215_{M}, 215_{S} and effects output from the at least one three-dimensional sensor 115_{M}, 115_{S}, 215_{M}, 215_{S} of a successive output array of pixelwise values PWV (FIG. 15, Block 1510). The controller 110, 112, 210, 512 receives pixelwise data PWD (FIG. 15, Block 1520) from the at least one three-dimensional sensor 115_{M}, 115_{S}, 215_{M}, 215_{S} so as to register (e.g., record in any suitable memory) each of the successive output arrays of pixelwise values PWV, where the controller 110, 112, 210, 512 is programmed with a correction factor LCF (see FIGS. 10 and 12) describing a pixelwise linearized response of the at least one three-dimensional sensor 115_{M}, 115_{S}, 215_{M}, 215_{S} to intensity variances characterized by calibration data of calibration fields of different reflection intensities, other than dark frame illumination. The controller 110, 112, 210, 512 corrects, in real time, with the correction factor LCF, the pixelwise data PWD of each of the successive output arrays of pixelwise values PWV and forms a succession of corrected depth map arrays CDMA, substantially invariant to different intensities of the illuminated objects in the field of view (FIG. 15, Block 1530). In the method, the at least one three-dimensional sensor 115_{M}, 115_{S}, 215_{M}, 215_{S} may be a ToF sensor. In the method, the pixelwise values PWV may be obtained from ToF data of the ToF sensor.

Another source of error may be since optical imagers are subject to a blurring function due to imperfections in the optical and sensor components used. This blur is described by a point spread function (PSF). This is particularly important in ToF sensors, where blur can hide small objects and cause edge effects. Thus, it is important to minimize this PSF with careful lens design, and to correct it when processing the sensor data.

In sensor design, it is important to consider the path of light through the entire imager, and to minimize the PSF. However, it may not be possible to fully eliminate the PSF due to the physical constraints of optical systems. As such, it is desirable to correct for the remaining effects in software. The PSF can be determined in at least three ways. First, the path of light through the sensor can be mathematically computed based on the lens design, giving a mathematically determined PSF. Second, the path can be simulated using optical software and a model of the lens, similarly determining a theoretical PSF. Finally, the PSF can be measured during sensor calibration. The measured data has the advantage of including lens focusing and electrical leakage effects. To measure the PSF, one of a few approaches can be used: a sharp, angled edge can be imaged by the sensor. By measuring the blur over this edge, the PSF can be determined. However, this assumes that the PSF is circular and constant over the imager. If this is not the case, a point source of light synchronized with the sensor's emission can be used. This point source will produce a blurred region in the image, which can be used to determine the PSF. If a synchronous light source (or sufficiently reflective surface) is not obtainable, one can also use a “dark frame” where the only illumination comes from a constant light point-source. The PSF is similarly calculated.

Once the PSF has been obtained, it can be used to correct the image at run-time, such as by the processing unit 110. In the noiseless case, this is as simple as convolving the inverse of the PSF with the image. However, on real data this amplifies noise. A wide range of alternative approaches can be used, including using a low-pass filter on the data before deconvolution, or using iterative approaches to minimize the difference between the image and the expected “uncorrupted” version of the image, which can be computed using the PSF.

Referring to FIGS. 1, 2, 5, 6, 10, and 12, the present disclosure provides for an image processing system (such as those described herein) that includes at least one three-dimensional sensors 115_{M}, 115_{S}, 215_{M}, 215_{S} and a controller (which controller may be processor 110, FPGA 112, FPGA 210, and/or controller 512). The at least one three-dimensional sensor 115_{M}, 115_{S}, 215_{M}, 215_{S} is for illuminating a corresponding field of view FOV of the sensor 115_{M}, 115_{S}, 215_{M}, 215_{S}, and generating an output array of pixelwise values PWV indicative of distances Rᵢ (see also FIG. 10) to illuminated objects in the field of view FOV. The controller 110, 112, 210, 512 is communicably connected to the at least one three-dimensional sensor 115_{M}, 115_{S}, 215_{M}, 215_{S} to effect output from the at least one three-dimensional sensor 115_{M}, 115_{S}, 215_{M}, 215_{S} of a successive output arrays of pixelwise values PWV, and to receive pixelwise data PWD from the at least one three-dimensional sensor 115_{M}, 115_{S}, 215_{M}, 215_{S} so as to register (e.g., record in any suitable memory) each of the successive output arrays of pixelwise values PWV. The controller 110, 112, 210, 512 is programmed with a correction factor BCF (see FIGS. 10 and 12) describing a pixelwise blurring of the at least one three-dimensional sensor 115_{M}, 115_{S}, 215_{M}, 215_{S} characterized by calibration data of calibration fields of different reflection intensities, other than dark frame illumination. The controller 110, 112, 210, 512 is configured to correct in real time, with the correction factor BCF, the pixelwise data PWD of each of the successive output arrays of pixelwise values PWV and form a succession of corrected depth map arrays CDMA, substantially invariant to different intensities of the illuminated objects in the field of view FOV. The at least one three-dimensional sensor 115_{M}, 115_{S}, 215_{M}, 215_{S} may be a time-of-flight sensor. The pixelwise values PWV may be obtained from time-of-flight data of the time-of-flight sensor. The calibration data characterizing the blurring may include a point spread function (such as described herein).

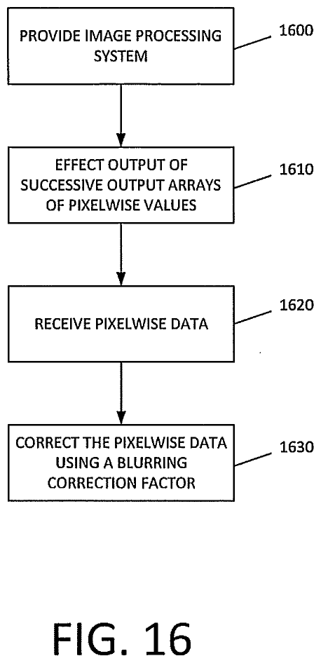

Referring to FIGS. 1, 2, 5, 6, 10, 12, and 16, the present disclosure provides for a method of correcting pixelwise data. The method includes providing an image processing system (such as those described herein) (FIG. 16, Block 1600) including at least one three-dimensional sensor 115_{M}, 115_{S}, 215_{M}, 215_{S} for illuminating a corresponding field of view FOV of the sensor 115_{M}, 115_{S}, 215_{M}, 215_{S}, and generating an output array of pixelwise values PWV indicative of distances Rᵢ (see also FIG. 10) to illuminated objects in the field of view FOV. The controller 110, 112, 210, 512 is communicably connected to the at least one three-dimensional sensor 115_{M}, 115_{S}, 215_{M}, 215_{S} and effects output from the at least one three-dimensional sensor 115_{M}, 115_{S}, 215_{M}, 215_{S} of a successive output arrays of pixelwise values PWV (FIG. 16, Block 1610). The controller 110, 112, 210, 512 receives pixelwise data PWD (FIG. 16, Block 1620) from the at least one three-dimensional sensor 115_{M}, 115_{S}, 215_{M}, 215_{S} so as to register (e.g., record in any suitable memory) each of the successive output arrays of pixelwise values PWV, where the controller 110, 112, 210, 512 is programmed with a correction factor BCF (see FIGS. 10 and 12) describing a pixelwise blurring of the at least one three-dimensional sensor 115_{M}, 115_{S}, 215_{M}, 215_{S} characterized by calibration data of calibration fields of different reflection intensities, other than dark frame illumination. The controller 110, 112, 210, 512 corrects, in real time, with the correction factor BCF, the pixelwise data PWD of each of the successive output arrays of pixelwise values PWV and forms a succession of corrected depth map arrays CDMA, substantially invariant to different intensities of the illuminated objects in the field of view (FIG. 15, Block 1530). In the method, the at least one three-dimensional sensor 115_{M}, 115_{S}, 215_{M}, 215_{S} may be a ToF sensor. In the method, the pixelwise values PWV may be obtained from ToF data of the ToF sensor. In the method, the calibration data characterizing the blurring may include a point spread function.

The following are provided in accordance with the present disclosure and may be employed individually, in any combination with each other, and/or in any combination with the features described herein:

An image processing system is provided and includes: at least two three-dimensional sensors each for illuminating a corresponding field of view of the sensor, and generating an output array of pixelwise values indicative of distances to illuminated objects in the field of view, each sensor being configured to generate illumination at least at two different frequencies so that objects in the corresponding field of view are illuminated at the two different frequencies; and a controller communicably connected to the at least two three-dimensional sensors to receive pixelwise data from each sensor embodying intensity and distance information from the illuminated objects, and the controller is configured so as disambiguate distance to each of the illuminated objects, resolve error in the received pixelwise data due to periodic distance ambiguity, and determine corrected pixelwise values indicative of true distance via each sensor illumination at the at least two different frequencies.

The image processing system includes one or more of the following individually, in any combination with each other, and/or in any combination with the features described herein: the controller is configured so as to disambiguate the distance and resolve error in the received pixelwise data of each sensor, and determine corrected pixelwise values of the output array of pixelwise values of each sensor indicative of the true distance; the controller is configured so that each sensor illumination at the at least two different frequencies describes a phase space in the corresponding field of view that characterizes the relationship of different measured intensities and corresponding measured distances, of each object embodied in the pixelwise data registered by the controller at the least two different frequencies; the phase space relationship is programmed in the controller and the phase space relationship characterizes the relation between differences in the measured intensities and in differences of the measured distances corresponding to the measured intensities in the pixelwise data; the controller is programed to identify discrepancies in measured distances from the measured intensities, the differences in the measured intensities, the measured distances and the differences of the measured distances and calculate a distance error in the measured distance; and the controller is programmed to determine a true distance value from the measured distance and distance error; the three-dimensional sensor is a time-of-flight sensor.

An automated logistic system including the image processing system, where the image processing system includes: at least two three-dimensional sensors each for illuminating a corresponding field of view of the sensor, and generating an output array of pixelwise values indicative of distances to illuminated objects in the field of view, each sensor being configured to generate illumination at least at two different frequencies so that objects in the corresponding field of view are illuminated at the two different frequencies; and a controller communicably connected to the at least two three-dimensional sensors to receive pixelwise data from each sensor embodying intensity and distance information from the illuminated objects, and the controller is configured so as disambiguate distance to each of the illuminated objects, resolve error in the received pixelwise data due to periodic distance ambiguity, and determine corrected pixelwise values indicative of true distance via each sensor illumination at the at least two different frequencies. The image processing system may also include one or more of the following individually, in any combination with each other, and/or in any combination with the features described herein: the controller is configured so as to disambiguate the distance and resolve error in the received pixelwise data of each sensor, and determine corrected pixelwise values of the output array of pixelwise values of each sensor indicative of the true distance; the controller is configured so that each sensor illumination at the at least two different frequencies describes a phase space in the corresponding field of view that characterizes the relationship of different measured intensities and corresponding measured distances, of each object embodied in the pixelwise data registered by the controller at the least two different frequencies; the phase space relationship is programmed in the controller and the phase space relationship characterizes the relation between differences in the measured intensities and in differences of the measured distances corresponding to the measured intensities in the pixelwise data; the controller is programed to identify discrepancies in measured distances from the measured intensities, the differences in the measured intensities, the measured distances and the differences of the measured distances and calculate a distance error in the measured distance; and the controller is programmed to determine a true distance value from the measured distance and distance error; the three-dimensional sensor is a time-of-flight sensor.

A method is provided and includes: providing an image processing system having at least two three-dimensional sensors each for illuminating a corresponding field of view of the sensor; generating, with each of the at least two three-dimensional sensors, an output array of pixelwise values indicative of distances to illuminated objects in the field of view, where each sensor is configured to generate illumination at least at two different frequencies so that objects in the corresponding field of view are illuminated at the two different frequencies; and receiving, with a controller communicably connected to the at least two three-dimensional sensors, pixelwise data from each sensor embodying intensity and distance information from the illuminated objects; and with the controller: disambiguating a distance to each of the illuminated objects, resolving error in the received pixelwise data due to periodic range ambiguity, and determining corrected pixelwise values indicative of true distance via each sensor illumination at the at least two different frequencies.

The method includes one or more of the following individually, in any combination with each other, and/or in any combination with the features described herein: the controller is configured so as to disambiguate the distance and resolve error in the received pixelwise data of each sensor, and determine corrected pixelwise values of the output array of pixelwise values of each sensor indicative of the true distance; the controller is configured so that each sensor illumination at the at least two different frequencies describes a phase space in the corresponding field of view that characterizes the relationship of different measured intensities and corresponding measured distances, of each object embodied in the pixelwise data registered by the controller at the least two different frequencies; the phase space relationship is programmed in the controller and the phase space relationship characterizes the relation between differences in the measured intensities and in differences of the measured distances corresponding to the measured intensities in the pixelwise data; with the controller: identifying discrepancies in measured ranges from the measured intensities, the differences in the measured intensities, the measured distances, and the differences of the measured distances, and calculating a distance error in the measured distance; with the controller, determining a true distance value from the measured distance and distance error; and the three-dimensional sensor is a time-of-flight sensor.

An image processing system is provided and includes: at least two three-dimensional sensors each for illuminating a corresponding field of view of the sensor, and generating an output array of pixelwise values indicative of distances to illuminated objects in the field of view, the at least two three-dimensional sensors being disposed to generate binocular images of the illuminated objects in the field of view; and a controller communicably connected to the at least two three-dimensional sensors to receive pixelwise data from each sensor so as to register the binocular images and configured to effect stereo matching from the binocular images resolving a pixelwise distance of the illuminated object, which pixelwise distance resolved from the binocular images corresponds to at least one pixel of the output array of pixelwise values of each three-dimensional sensor; and wherein the controller is configured to validate an uncertain pixelwise value of the at least one pixel of the output array of pixelwise values of one of the at least two three-dimensional sensors.

The image processing system includes one or more of the following individually, in any combination with each other, and/or in any combination with the features described herein: the pixelwise distance resolved from binocular images forms a third measure of confidence relative to the pixelwise values of the output array of pixelwise values; the pixelwise distance resolved from binocular images is determined substantially simultaneously with obtaining the pixelwise values of the output array of pixelwise values; each of the at least two three-dimensional sensors is a ToF sensor and the pixelwise values are obtained from ToF data of the sensor; and the controller is configured so as to provide the comparison unit with the validated pixelwise value of the sensor validated from the binocular vision.

An automated logistic system including the image processing system, where the image processing system includes: at least two three-dimensional sensors each for illuminating a corresponding field of view of the sensor, and generating an output array of pixelwise values indicative of distances to illuminated objects in the field of view, the at least two three-dimensional sensors being disposed to generate binocular images of the illuminated objects in the field of view; and a controller communicably connected to the at least two three-dimensional sensors to receive pixelwise data from each sensor so as to register the binocular images and configured to effect stereo matching from the binocular images resolving a pixelwise distance of the illuminated object, which pixelwise distance resolved from the binocular images corresponds to at least one pixel of the output array of pixelwise values of each three-dimensional sensor; and wherein the controller is configured to validate an uncertain pixelwise value of the at least one pixel of the output array of pixelwise values of one of the at least two three-dimensional sensors. The image processing system may also include one or more of the following individually, in any combination with each other, and/or in any combination with the features described herein: the pixelwise distance resolved from binocular images forms a third measure of confidence relative to the pixelwise values of the output array of pixelwise values; the pixelwise distance resolved from binocular images is determined substantially simultaneously with obtaining the pixelwise values of the output array of pixelwise values; each of the at least two three-dimensional sensors is a time-of-flight sensor and the pixelwise values are obtained from time-of-flight data of the sensor; and the controller is configured so as to provide the comparison unit with the validated pixelwise value of the sensor validated from the binocular vision.

A method is provided and includes: providing an image processing system having at least two three-dimensional sensors each for illuminating a corresponding field of view of the sensor, and generating an output array of pixelwise values indicative of distances to illuminated objects in the field of view, the at least two three-dimensional sensors being disposed to generate binocular images of the illuminated objects in the field of view; and receiving, with a controller communicably connected to the at least two three-dimensional sensors, pixelwise data from each sensor so as to register the binocular images; effecting, with the controller, stereo matching from the binocular images resolving a pixelwise distance of the illuminated object, which pixelwise distance resolved from binocular images corresponds to at least one pixel of the output array of pixelwise values of each three-dimensional sensor; and validating, with the controller, an uncertain pixelwise value of the at least one pixel of the output array of pixelwise values of one of the at least two three-dimensional sensors.

The method includes one or more of the following individually, in any combination with each other, and/or in any combination with the features described herein: the pixelwise distance resolved from binocular images forms a third measure of confidence relative to the pixelwise values of the output array of pixelwise values; the pixelwise distance resolved from binocular images is determined substantially simultaneously with obtaining the pixelwise values of the output array of pixelwise values; each of the at least two three-dimensional sensors is a time-of-flight sensor and the pixelwise values are obtained from time-of-flight data of the sensor; and the controller provides the comparison unit with the validated pixelwise value of the sensor validated from the binocular vision.

An image processing system is provided and includes: at least two three-dimensional sensors each for illuminating a corresponding field of view of the sensor, and generating an output array of pixelwise values indicative of distances to illuminated objects in the field of view; and a controller communicably connected to the at least two three-dimensional sensors to receive pixelwise data from each sensor so as to register the output array of pixelwise values as a measured depth map array of the illuminated objects, the controller being configured to search for and find high frequency gradient pixels within the depth map array in substantially real time; and wherein the controller is further configured to identify a neighbor pixel, to each high frequency gradient pixel within the depth map array, with a value indicating a minimum distance to the illuminated objects and set the minimum distance as a true minimum distance to the illuminated objects.

The image processing system includes one or more of the following individually, in any combination with each other, and/or in any combination with the features described herein: the controller is programmed with a look up table of edge effect correction factors as a function of distance described by calibration data characterizing pixelwise response to edge effects as a function of distance for each sensor; and the controller finds the high frequency gradient pixels within the depth map array substantially in real time based on convolving the depth map array with an edge detector and application of the edge effect correction factors from the look up table.

An automated logistic system is provided and includes the image processing system, where the imaging processing system includes: at least two three-dimensional sensors each for illuminating a corresponding field of view of the sensor, and generating an output array of pixelwise values indicative of distances to illuminated objects in the field of view; and a controller communicably connected to the at least two three-dimensional sensors to receive pixelwise data from each sensor so as to register the output array of pixelwise values as a measured depth map array of the illuminated objects, the controller being configured to search for and find high frequency gradient pixels within the depth map array in substantially real time; and wherein the controller is further configured to identify a neighbor pixel, to each high frequency gradient pixel within the depth map array, with a value indicating a minimum distance to the illuminated objects and set the minimum distance as a true minimum distance to the illuminated objects. The image processing system may also include one or more of the following individually, in any combination with each other, and/or in any combination with the features described herein: the controller is programmed with a look up table of edge effect correction factors as a function of distance described by calibration data characterizing pixelwise response to edge effects as a function of distance for each sensor; and the controller finds the high frequency gradient pixels within the depth map array substantially in real time based on convolving the depth map array with an edge detector and application of the edge effect correction factors from the look up table.

A method is provided and includes: providing an image processing system having at least two three-dimensional sensors each for illuminating a corresponding field of view of the sensor, and generating an output array of pixelwise values indicative of distances to illuminated objects in the field of view; receiving, with a controller communicably connected to the at least two three-dimensional sensors, pixelwise data from each sensor so as to register the output array of pixelwise values as a measured depth map array of the illuminated objects; searching for and finding, with the controller, high frequency gradient pixels within the depth map array in substantially real time; and identifying, with the controller, a neighbor pixel, to each high frequency gradient pixel within the depth map array, with a value indicating a minimum distance to the illuminated objects and setting the minimum distance as a true minimum distance to the illuminated objects.

The method may also include one or more of the following individually, in any combination with each other, and/or in any combination with the features described herein: the controller is programmed with a look up table of edge effect correction factors as a function of distance described by calibration data characterizing pixelwise response to edge effects as a function of distance for each sensor; and the controller finds the high frequency gradient pixels within the depth map array substantially in real time based on convolving the depth map array with an edge detector and application of the edge effect correction factors from the look up table.

An image processing system is provided and includes: at least one three-dimensional sensor for illuminating a corresponding field of view of the sensor, and generating an output array of pixelwise values indicative of distances to illuminated objects in the field of view; and a controller communicably connected to the at least one three-dimensional sensor to effect output from the at least one three-dimensional sensor of a successive output arrays of pixelwise values, and to receive pixelwise data from the at least one three-dimensional sensor so as to register each of the successive output arrays of pixelwise values; wherein the controller is programmed with a correction factor describing a pixelwise linearized response of the at least one three-dimensional sensor to intensity variances characterized by calibration data of calibration fields of different reflection intensities, other than dark frame illumination, and wherein the controller is configured to correct in real time, with the correction factor, the pixelwise data of each of the successive output arrays of pixelwise values and form a succession of corrected depth map arrays, substantially invariant to different intensities of the illuminated objects in the field of view.

The image processing system may also include one or more of the following individually, in any combination with each other, and/or in any combination with the features described herein: the at least one three-dimensional sensor is a time-of-flight sensor; and the pixelwise values are obtained from time-of-flight data of the time-of-flight sensor.

An automated logistic system is provided and including the image processing system, where the image processing system includes at least one three-dimensional sensor for illuminating a corresponding field of view of the sensor, and generating an output array of pixelwise values indicative of distances to illuminated objects in the field of view; and a controller communicably connected to the at least one three-dimensional sensor to effect output from the at least one three-dimensional sensor of a successive output arrays of pixelwise values, and to receive pixelwise data from the at least one three-dimensional sensor so as to register each of the successive output arrays of pixelwise values; wherein the controller is programmed with a correction factor describing a pixelwise linearized response of the at least one three-dimensional sensor to intensity variances characterized by calibration data of calibration fields of different reflection intensities, other than dark frame illumination, and wherein the controller is configured to correct in real time, with the correction factor, the pixelwise data of each of the successive output arrays of pixelwise values and form a succession of corrected depth map arrays, substantially invariant to different intensities of the illuminated objects in the field of view. The image processing system may also include one or more of the following individually, in any combination with each other, and/or in any combination with the features described herein: the at least one three-dimensional sensor is a time-of-flight sensor; and the pixelwise values are obtained from time-of-flight data of the time-of-flight sensor.

A method is provided and includes: providing an image processing system including at least one three-dimensional sensor for illuminating a corresponding field of view of the at least one three-dimensional sensor, and generating an output array of pixelwise values indicative of distances to illuminated objects in the field of view; effecting, with a controller communicably connected to the at least one three-dimensional sensor, output from the at least one three-dimensional sensor of successive output arrays of pixelwise values; receiving, with the controller, pixelwise data from the at least one three-dimensional sensor so as to register each of the successive output arrays of pixelwise values, wherein the controller is programmed with a correction factor describing a pixelwise linearized response of the at least one three-dimensional sensor to intensity variances characterized by calibration data of calibration fields of different reflection intensities, other than dark frame illumination; and correcting in real time, with the controller, with the correction factor, the pixelwise data of each of the successive output arrays of pixelwise values and forms a succession of corrected depth map arrays, substantially invariant to different intensities of the illuminated objects in the field of view.

The method may also include one or more of the following individually, in any combination with each other, and/or in any combination with the features described herein: the at least one three-dimensional sensor is a time-of-flight sensor; and the pixelwise values are obtained from time-of-flight data of the time-of-flight sensor.

An image processing system is provided and includes: at least one three-dimensional sensor for illuminating a corresponding field of view of the at least one three-dimensional sensor, and generating an output array of pixelwise values indicative of distances to illuminated objects in the field of view; and a controller communicably connected to the at least one three-dimensional sensor to effect output from the at least one three-dimensional sensor of successive output arrays of pixelwise values, and to receive pixelwise data from the at least one three-dimensional sensor so as to register each of the successive output arrays of pixelwise values; wherein the controller is programmed with a correction factor describing a pixelwise blurring of the at least one three-dimensional sensor characterized by calibration data of calibration fields of different reflection intensities, other than dark frame illumination, and wherein the controller is configured to correct in real time, with the correction factor, the pixelwise data of each of the successive output arrays of pixelwise values and form a succession of corrected depth map arrays, substantially invariant to different intensities of the illuminated objects in the field of view.

The image processing system may also include one or more of the following individually, in any combination with each other, and/or in any combination with the features described herein: the at least one three-dimensional sensor is a time-of-flight sensor; the pixelwise values are obtained from time-of-flight data of the time-of-flight sensor; and the calibration data characterizing the blurring includes a point spread function.

An automated logistic system is provided and includes the image processing system, where the image processing system includes at least one three-dimensional sensor for illuminating a corresponding field of view of the at least one three-dimensional sensor, and generating an output array of pixelwise values indicative of distances to illuminated objects in the field of view; and a controller communicably connected to the at least one three-dimensional sensor to effect output from the at least one three-dimensional sensor of successive output arrays of pixelwise values, and to receive pixelwise data from the at least one three-dimensional sensor so as to register each of the successive output arrays of pixelwise values; wherein the controller is programmed with a correction factor describing a pixelwise blurring of the at least one three-dimensional sensor characterized by calibration data of calibration fields of different reflection intensities, other than dark frame illumination, and wherein the controller is configured to correct in real time, with the correction factor, the pixelwise data of each of the successive output arrays of pixelwise values and form a succession of corrected depth map arrays, substantially invariant to different intensities of the illuminated objects in the field of view. The image processing system may also include one or more of the following individually, in any combination with each other, and/or in any combination with the features described herein: the at least one three-dimensional sensor is a time-of-flight sensor; the pixelwise values are obtained from time-of-flight data of the time-of-flight sensor; and the calibration data characterizing the blurring includes a point spread function.

A method is provided and includes: providing an image processing system including at least one three-dimensional sensor for illuminating a corresponding field of view of the at least one three-dimensional sensor, and generating an output array of pixelwise values indicative of distances to illuminated objects in the field of view; effecting, with a controller communicably connected to the at least one three-dimensional sensor, output from the at least one three-dimensional sensor of successive output arrays of pixelwise values; receiving, with the controller, pixelwise data from the at least one three-dimensional sensor so as to register each of the successive output arrays of pixelwise values, wherein the controller is programmed with a correction factor describing a pixelwise blurring of the at least one three-dimensional sensor characterized by calibration data of calibration fields of different reflection intensities, other than dark frame illumination; and correcting in real time, with the controller, with the correction factor, the pixelwise data of each of the successive output arrays of pixelwise values and form a succession of corrected depth map arrays, substantially invariant to different intensities of the illuminated objects in the field of view.

The method may also include one or more of the following individually, in any combination with each other, and/or in any combination with the features described herein: the at least one three-dimensional sensor is a time-of-flight sensor; the pixelwise values are obtained from time-of-flight data of the time-of-flight sensor; and the calibration data characterizing the blurring includes a point spread function.

Certain aspects of the present disclosure are described above. It is, however, expressly noted that the present invention is not limited to those aspects; rather, additions and modifications to what is expressly described herein are also included within the scope of the invention. Accordingly, the present disclosure is intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the present disclosure.

What is claimed is:

1. An image processing system comprising:
at least two three-dimensional sensors each for illuminating a corresponding field of view of the sensor, and generating an output array of pixelwise values indicative of distances to illuminated objects in the field of view, each sensor being configured to generate illumination at least at two different frequencies so that objects in the corresponding field of view are illuminated at the two different frequencies; and
a controller communicably connected to the at least two three-dimensional sensors to receive pixelwise data from each sensor embodying intensity and distance information from the illuminated objects, and the controller is configured so as disambiguate a distance to each of the illuminated objects, resolve error in the received pixelwise data due to periodic distance ambiguity, and determine corrected pixelwise values indicative of true distance via each sensor illumination at the at least two different frequencies.

2. The image processing system of claim 1, wherein the controller is configured so as to disambiguate the distance and resolve error in the received pixelwise data of each sensor and determine corrected pixelwise values of the output array of pixelwise values of each sensor indicative of the true distance.

3. The image processing system of claim 1, wherein the controller is configured so that each sensor illumination at the at least two different frequencies describes a phase space in the corresponding field of view that characterizes the relationship of different measured intensities and corresponding measured distances, of each object embodied in the pixelwise data registered by the controller at the least two different frequencies.

4. The image processing system of claim 3, wherein the phase space relationship is programmed in the controller and the phase space relationship characterizes the relation between differences in the measured intensities and in differences of the measured distances corresponding to the measured intensities in the pixelwise data.

5. The image processing system of claim 3, wherein the controller is programed to identify discrepancies in measured distances from the measured intensities, the differences in the measured intensities, the measured distances and the differences of the measured distances and calculate a distance error in the measured distance.

6. The image processing system of claim 5, wherein the controller is programmed to determine a true distance value from the measured distance and distance error.

7. The image processing system of claim 1, wherein the three-dimensional sensor is a time-of-flight sensor.

8. An automated logistic system including the image processing system of claim 1.

9. The automated logistic system of claim 8, wherein the controller is configured so as to disambiguate the distance and resolve error in the received pixelwise data of each sensor and determine corrected pixelwise values of the output array of pixelwise values of each sensor indicative of the true distance.

10. The automated logistic system of claim 8, wherein the controller is configured so that each sensor illumination at the at least two different frequencies describes a phase space in the corresponding field of view that characterizes the relationship of different measured intensities and corresponding measured distances, of each object embodied in the pixelwise data registered by the controller at the least two different frequencies.

11. The automated logistic system of claim 10, wherein the phase space relationship is programmed in the controller and the phase space relationship characterizes the relation between differences in the measured intensities and in differences of the measured distances corresponding to the measured intensities in the pixelwise data.

12. The automated logistic system of claim 10, wherein the controller is programed to identify discrepancies in measured distances from the measured intensities, the differences in the measured intensities, the measured distances and the differences of the measured distances and calculate a distance error in the measured distance.

13. The automated logistic system of claim 12, wherein the controller is programmed to determine a true distance value from the measured distance and distance error.

14. A method comprising:
providing an image processing system having at least two three-dimensional sensors each for illuminating a corresponding field of view of the sensor;
generating, with each of the at least two three-dimensional sensors, an output array of pixelwise values indicative of distances to illuminated objects in the field of view, where each sensor is configured to generate illumination at least at two different frequencies so that objects in the corresponding field of view are illuminated at the two different frequencies; and
receiving, with a controller communicably connected to the at least two three-dimensional sensors, pixelwise data from each sensor embodying intensity and distance information from the illuminated objects; and
with the controller:
disambiguating a distance to each of the illuminated objects,
resolving error in the received pixelwise data due to periodic range ambiguity, and
determining corrected pixelwise values indicative of true distance via each sensor illumination at the at least two different frequencies.

15. The method of claim 14, wherein the controller is configured so as to disambiguate the distance and resolve error in the received pixelwise data of each sensor and determine corrected pixelwise values of the output array of pixelwise values of each sensor indicative of the true distance.

16. The method of claim 14, wherein the controller is configured so that each sensor illumination at the at least two different frequencies describes a phase space in the corresponding field of view that characterizes the relationship of different measured intensities and corresponding measured distances, of each object embodied in the pixelwise data registered by the controller at the least two different frequencies.

17. The method of claim 16, wherein the phase space relationship is programmed in the controller and the phase space relationship characterizes the relation between differences in the measured intensities and in differences of the measured distances corresponding to the measured intensities in the pixelwise data.

18. The method of claim 16, further comprising, with the controller:
identifying discrepancies in measured ranges from the measured intensities, the differences in the measured intensities, the measured distances, and the differences of the measured distances, and
calculating a distance error in the measured distance.

19. The method of claim 18, further comprising, with the controller, determining a true distance value from the measured distance and distance error.

20. The method of claim 14, wherein the three-dimensional sensor is a time-of-flight sensor.
